(19) United States
(12) Patent Application Publication
(10) Pub. No.: US 2016/0342955 A1
(43) Pub. Date: Nov. 24, 2016

(54) MULTI-ENTITY EVENT COORDINATION SERVER AND SYSTEM

(71) Applicant: DAYSAVER, INC., SEATTLE, WA (US)

(72) Inventors: Philip J. Brock, Seattle, WA (US); Jenny VanSeters, Seattle, WA (US); Scott Westgaard, Seattle, WA (US)

(21) Appl. No.: 15/162,569

(22) Filed: May 23, 2016

Related U.S. Application Data
(63) Continuation-in-part of application No. 14/708,101, filed on May 8, 2015, now abandoned.

(51) Int. Cl. G06Q 10/10; G06F 3/0482; H04L 29/08

(52) U.S. Cl. CPC G06Q 10/1095; H04L 67/1095; H04L 67/20; G06F 3/0482

(57) ABSTRACT

Embodiments of the present technology are directed to multi-entity calendar and time management displays and methods of use. An example multi-entity calendar interface can include savers for a plurality of entities, the savers having calendar events for an entity, the calendar events arranged in columnar format such that calendar events are displayed for each of the plurality of entities simultaneously in the multi-entity calendar interface, the calendar events being aligned with one another across the calendar interface according to time.

### CROSS-REFERENCE TO RELATED APPLICATIONS

The present application is a Continuation-in-Part of U.S. patent application Ser. No. 14/708,101, entitled “SYSTEMS AND METHODS FOR AN INTEGRATED CALENDARING APPLICATION,” filed May 8, 2015 (docket number 3031-001-03T); which, to the extent not inconsistent with the disclosure herein, is incorporated by reference.

### SUMMARY

According to an embodiment, a computer server includes a processor, memory, and communication transceiver. The computer server is configured to receive, via the communication transceiver, a calendar request for user calendar data associated with a user, the request including at least calendar access information. The computer server accesses the user calendar data in a first calendar storage based on the calendar access information, the user calendar data including zero or more user events, accesses entity calendar data associated with an entity other than the user, the entity calendar data located at a second calendar storage, the entity calendar data including zero or more entity events, and transmits, via the communication transceiver, elements representing the user calendar data and at least a portion of the entity calendar data for simultaneous display at a user service. The computer server can receive, via the communication transceiver from the user service, a scheduling inquiry, the scheduling inquiry including one or more request parameters, the one or more request parameters including at least one of: an entity identifier, a date, a start time, an end time, an event type, and an entity event resource. The computer server identifies, via the processor, as a potential entity event each of the entity events that is available and that satisfies the one or more request parameters of the scheduling inquiry, transmits, via the communication transceiver to the user service, each potential entity event, receives from the user service a selection communication identifying a selected entity calendar event from among the potential entity event that satisfy the one or more request parameters, updates the entity calendar data to show the selected entity calendar event as no longer available, and updates the user calendar data to show the selected entity calendar event.

According to an embodiment, a schedule coordination server has circuitry configured to retrieve, from a first electronic schedule storage, a schedule of a first entity; retrieve, from a second electronic schedule storage, a schedule of a second entity; and provide to a device of the first entity elements representing at least a portion of the schedule of the first entity and at least a portion of the schedule of the second entity. The schedule coordination server can electronically receive, from the device of the first entity, a scheduling inquiry to identify a mutually available event time associated with an event offered by the second entity, the scheduling inquiry including scheduling parameters for identifying a mutually available event time; identify a set of first entity events in the schedule of the first entity that intersect with the scheduling parameters; and identify a set of second entity events in the schedule of the second entity that intersect with the scheduling parameters. The schedule coordination server calculates availability time spans for the second entity that satisfy the scheduling parameters, that do not conflict with the set of first entity events, and that do not conflict with the set of second entity events and provide the calculated availability time spans for display at the device of the first entity. The schedule coordination server can then receive from the first entity a selection identifying one of the presented time spans and update the schedule of the first entity and the schedule of the second entity to indicate that the one of the presented time spans is associated with a scheduled event.

According to an embodiment, a method for electronically reserving a mutually available event, the method includes the steps of receiving data corresponding to a scheduling availability inquiry from a first entity, the scheduling availability inquiry including limiting parameters, the limiting parameters including at least a requested start date, a requested end date, and a requested event duration; identifying, in a first entity electronic calendar, all available time periods from the requested start date through the requested end date that have the requested event duration; and generating presentation elements corresponding to a portion of the first entity electronic calendar for perceptibly indicating the identified available time periods. The method can include receiving a selection of one or more of said any available time periods and an identity of a second entity, identifying in a second entity electronic calendar any second entity events that are available and correspond to the selection of one or more of said any available time periods, and generating display elements corresponding to a portion of the second entity electronic calendar and including the identified any second entity events. Proceeding, the method can include receiving a first entity event selection of one of the identified second entity events, updating the first entity electronic calendar to include the one of the identified second entity events from the first entity event selection, and updating the second entity electronic calendar to indicate as reserved the one of the identified second entity events from the first entity event selection.

According to an embodiment, a computing apparatus includes a processor, a communication transceiver, and a memory carrying computer-executable instructions. The computer-executable instructions, when executed by the processor, cause the computing apparatus to receive a scheduling availability inquiry from a first entity, the scheduling availability inquiry including limiting parameters, the limiting parameters including at least a requested start date, a requested end date, and a requested event duration; identify, in a first entity electronic calendar, all available time periods from the requested start date through the requested end date that have the requested event duration; and generate presentation elements corresponding to a portion of the first entity electronic calendar for perceptibly indicating the identified available time periods. The computer-executable instructions further cause the computing apparatus to receive a selection of one or more of said any available time periods, and an identity of a second entity; identify in a second entity electronic calendar any second entity events that are available and correspond to the selection of one or more of said any available time periods; and generate display elements corresponding to a portion of the second entity electronic calendar and including the identified any second entity events. The computer-executable instructions further cause the computing apparatus to receive a first entity selection of one of the identified second entity events, update the first entity electronic calendar to include the selected one of the identified second entity events, and update the second entity electronic calendar to indicate as reserved the selected one of the identified second entity events.

### BRIEF DESCRIPTION OF THE DRAWINGS

The accompanying drawings, where like reference numerals refer to identical or functionally similar elements throughout the separate views, together with the detailed description below, are incorporated in and form part of the specification, and serve to further illustrate embodiments of concepts that include the claimed disclosure, and explain various principles and advantages of those embodiments.

The methods and systems disclosed herein have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

FIG. 1 is a schematic diagram of an example computing architecture that is utilized to implement some embodiments of the present technology.

FIG. 2A is a schematic diagram of the layout for a multi-entity calendar interface where the vertical time dimension represents minutes and hours.

FIG. 2B is a schematic diagram of the layout for a multi-entity calendar interface where the vertical time dimension represents days, and the horizontal dimension within each day (row) represents the hours in the day.

FIG. 3A is an example multi-entity calendar interface comprising a plurality of savers in “day” mode.

FIG. 3B is an example multi-entity calendar interface comprising a plurality of savers in “week” mode.

FIG. 3C is an example multi-calendar interface comprising a selection of savers in “day” mode.

FIG. 3D is an example multi-calendar interface comprising a view of selected savers in “day” mode.

FIG. 4 is an example multi-entity calendar interface that includes modified calendar events.

FIG. 5 is a flow diagram illustrating landing and active stages for a calendaring process.

FIG. 6 illustrates example vertical and horizontal wire frames for creating multi-entity calendars.

FIG. 7 is a detailed wireframe for defining app states and sub states for calendar entries.

FIG. 8 illustrates an exemplary Unified Modeling Language (UML) diagram for the Time AppState.

FIG. 9 illustrates an example multi-entity calendar with reference to Navbar, AppState, and Tool Bar UML features of FIG. 8.

FIG. 10 illustrates an example UI that allows a user (merchant) to create a calendar appointment.

FIG. 11 illustrates an exemplary Unified Modeling Language (UML) diagram for the notifications AppState.

FIGS. 12 and 13 collectively illustrate notification UIs that allow users to converse regarding a shared calendar event.

FIG. 14 illustrates an exemplary Unified Modeling Language (UML) diagram for the Savers AppState as well as a user interface (UI) assembled using the UML.

FIG. 15 illustrates an example system that is comprised of tiers, which is used to organize aspects of the present technology.

FIG. 16 is a signal flow diagram of example methods within the system of FIG. 15.

FIG. 17 is a flowchart of an example method for generating a multi-entity calendar interface.

FIG. 18 is a flowchart of an example method for sharing and using savers of the present technology.

FIG. 19 is a schematic diagram of an example computer system that can be used to implement aspects of the present technology.

FIG. 20 is a signal flow diagram for an example multi-entity event coordination system.

FIG. 21 is a flowchart of an example method of operating a multi-entity event coordination system according to an embodiment.

FIG. 22 is a flowchart detailing an element of the flowchart of FIG. 21.

FIG. 23 is a flowchart of an example method of operating client device of a multi-entity event coordination system according to an embodiment.

### DETAILED DESCRIPTION

In the following detailed description, reference is made to the accompanying drawings, which form a part hereof. In the drawings, similar symbols typically identify similar components, unless context dictates otherwise. Other embodiments may be used and/or other changes may be made without departing from the spirit or scope of the disclosure.

Embodiments of the present technology describe a schedule comparison and mutual appointment setting tool that makes personal time management easier and more efficient for a user, as well as making business and customer time management more powerful for the business user. The schedule comparison and mutual appointment setting tool is described below in terms of an exemplary embodiment. A user may use the schedule comparison and mutual appointment setting tool to integrate for simultaneous viewing and interaction one or more hosted personal calendars with hosted calendars for service providers, businesses, maps, and other users' personal calendars. A business user may use the calendaring application to integrate one or more service related calendars related to their business.

The present technology is implemented in a Software-as-a-Service embodiment, where the calendaring functionalities are executed on a server or within a cloud. Users access the calendaring functionalities via an interactive display presented on their client device or browser.

In another embodiment, the present technology is implemented as a native application that executes on a client device.

The multi-entity event coordination application has been designed to make personal and business time management easier, more efficient and more powerful. The calendaring application eliminates or reduces the need for context switching between applications and web-sites for the primary time management tasks in a person's life, or service provider's business hours. The calendaring application extends the concept of a calendar to include merchants, which can include those merchants that provide recurring services or goods frequently utilized or purchased by the user. The calendaring application creates an ecosystem of contacts, time management affordances, and time-based information that can be added to and interoperate with a user or merchant calendar. The calendaring application also allows for the integration of a user's own multiple calendars (e.g. business and personal), and for sharing and integration of one or more aspects of a user's calendar with others. The sharing and integration of a user's (e.g., a business's) calendar may include providing to another party at least an event from the user's calendar for display at another device, the event being reservable at another device.

For example, a first user can select an event from his/her calendar to share with one or more additional users. As one example, the event could include a dinner reservation. The first user can share the calendar event for the reservation with a plurality of invitees by selecting the calendar entry and specifying the invitee with whom they will share the event. The invitee(s) may view the shared calendar event in a client calendar application configured to receive the invitation and/or automatically populate the event according to approaches described herein.

In another embodiment, the calendar for a user is an amalgamation of shared events between the user and additional other users that maintain their own calendar files. While the user can maintain their own personal events in the calendar, the presently disclosed technology allows for the user's calendar interface to display shared event notifications and calendars.

Thus, the calendaring application may integrate all of a user's time management tasks in one cohesive display. The resulting calendar is presented in a single application accessible on a wide range of devices, anywhere and anytime. Supported consumer devices include, but are not limited to, smart-phones, tablets, laptops, desktops, and televisions. As mentioned above, the calendaring application may be an n-tier, web-based system accessible to users via a browser or downloadable hybrid application.

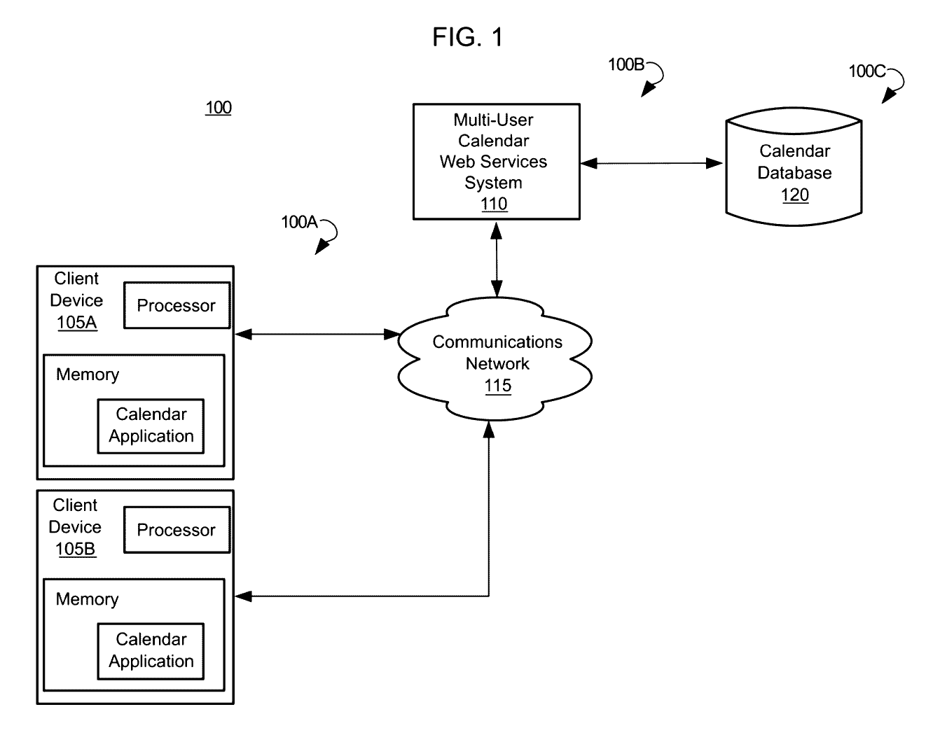

Referring now to FIG. 1, the calendaring application may be, in some embodiments, implemented using a three-tier, client-server architecture 100. The tiers may include a first, presentation tier 100A, a second, business logic tier 1008, and a third, data tier 100C.

The presentation tier 100A may represent the end user portion of the experience. For example, the presently disclosed technology may be implemented on a client device as a web-site running in a browser, or a hybrid application (native code wrapper around a web-based graphical user interface) downloaded and executing on the client device.

The business logic tier 1008 may be implemented as a web service, such as a Representational State Transfer (REST) or Simple Object Access Protocol (SOAP)-compliant web service. The business logic tier 1008 may communicate with the presentation tier's client application via HTTP or other web communication protocol over, e.g., a communications network 115, handling requests and returning responses. In order to process requests, the business logic tier 1008 may communicate with database(s) 120 of the data-tier 100C, with other private web services performing specialized logic, and/or third-party web services. Third-party web services may be accessed via HTTP or other data transfer protocols over the World Wide Web or other network. The data-tier database(s) 120 and other private web services may be communicated with behind a secure firewall (not illustrated).

The third, data-tier 100C may include one or more proprietary databases used to store user information and/or product information concerning the multi-entity event coordination application ecosystem of contacts and affordances. At the time of this disclosure, Google Calendar is one example of a proprietary database used to store user information.

In more detail, the presentation tier 100A may include one or more client devices 105A and 1058, used by end users. Each of the client devices comprises at least a processor and non-transitory memory for storing executable instructions. In some embodiments, the memory may store processor-executable instructions for managing and displaying an application that provides the schedule comparison and mutual appointment setting features and interfaces described herein. In some embodiments, the client devices 105A, 105B can access the calendaring features of the present technology by communicating with a multi-user calendar web services system 110 over a communications network 115.

The multi-user calendar web service system 110 may include a server computer, an array of server computers, a server farm or the like. The multi-user calendar web service system 110 may include one or more processors, non-transitory memory device(s), and communication transceiver(s).

Suitable communications networks 115 may include or interface with any one or more of, for instance, a local intranet, a PAN (Personal Area Network), a LAN (Local Area Network), a WAN (Wide Area Network), a MAN (Metropolitan Area Network), a virtual private network (VPN), a storage area network (SAN), a frame relay connection, an Advanced Intelligent Network (AIN) connection, a synchronous optical network (SONET) connection, a digital T1, T3, E1 or E3 line, Digital Data Service (DDS) connection, DSL (Digital Subscriber Line) connection, an Ethernet connection, an ISDN (Integrated Services Digital Network) line, a dial-up port such as a V.90, V.34 or V.34b is analog modem connection, a cable modem, an ATM (Asynchronous Transfer Mode) connection, or an FDDI (Fiber Distributed Data Interface) or CDDI (Copper Distributed Data Interface) connection or combinations of any of these. Furthermore, communications may also include links to any of a variety of wireless networks, including 4GLTE (Long Term Evolution), 3GPP (3G Radio Access Network), WAP (Wireless Application Protocol), GPRS (General Packet Radio Service), GSM (Global System for Mobile Communication), CDMA (Code Division Multiple Access) or TDMA (Time Division Multiple Access), cellular phone networks, GPS (Global Positioning System), CDPD (cellular digital packet data), RIM (Research in Motion, Limited) duplex paging network, Bluetooth radio, or an IEEE 802.11-based radio frequency network or combinations of any of these. The communications network 115 can further include or interface with any one or more of an RS-232 serial connection, an IEEE-1394 (Firewire) connection, a Fiber Channel connection, an IrDA (infrared) port, a SCSI (Small Computer Systems Interface) connection, a USB (Universal Serial Bus) connection or other wired or wireless, digital or analog interface or connection, mesh or Digi®networking.

The calendar database 120 can be utilized to store user account information; individual entity calendars (e.g., savers) including events with associated times, durations, attendees, locations, and/or other pertinent information; as well as other user or system data and associations between such information and data.

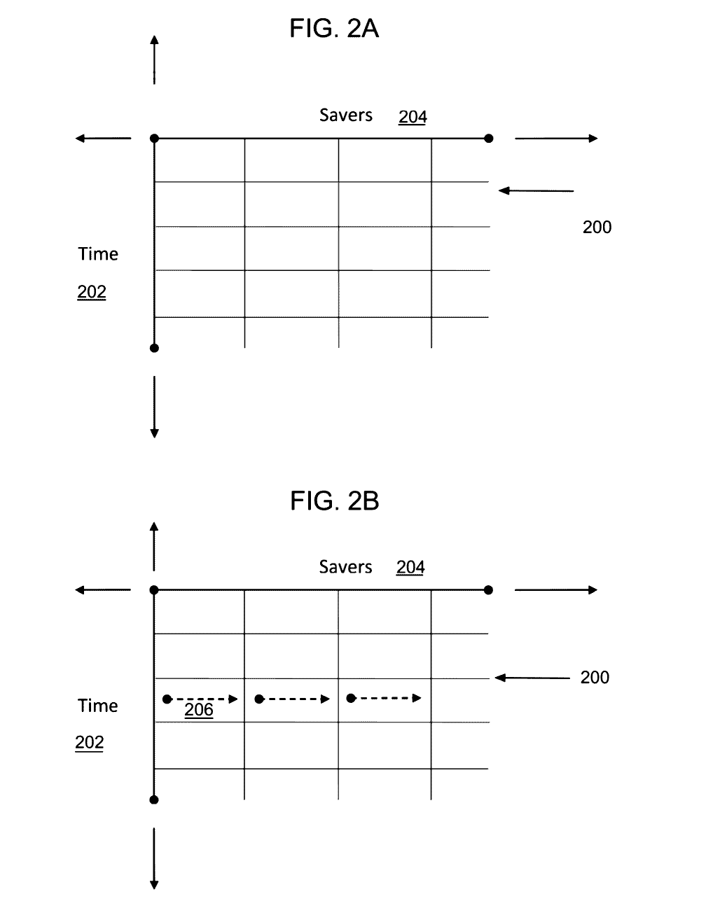

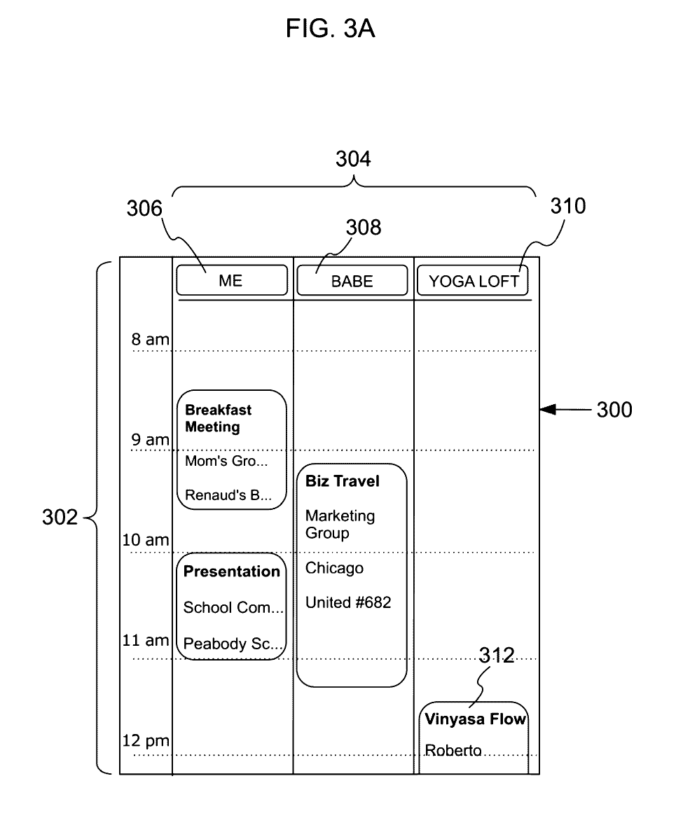

FIGS. 2-16 collectively illustrate views of a client application User Experience (UX) before the workflow and schematic wireframes are described in following figures.

The present technology involves the use of a “saver.” Generally, a saver can comprise any one or more time management functionalities. In an example embodiment, there may be initially three saver types: (a) a calendar which comprises a standard calendar format; (b) a service provider such as a (merchant) calendar that provides time-based—in some instances recurring—services or commodities. Examples of these service providers include, but are not limited to a healthcare clinic, a hair salon, an airline, a restaurant, a sports team, a band, a theater, fitness instructor and any combinations thereof—just to name a few; and (c) an affordance that is a feature for organizing time-based information such as photos, reminders, birthdays, “to do” lists, and so forth.

In some embodiments, a saver may have its own time-based events, its own GUI for managing its events, and sometimes its own style of displaying its events. In the case of service providers, a saver may also have its own user configurable preferences. For example, if the merchant is dedicated to a hair salon, the saver could comprise a calendar for a stylist at a hair salon of the end user's preference.

However, savers, in some embodiments, have in common the element of time, and can thus be represented and displayed in relation to one another. Thus, each saver may be represented as an individual software module, where each module may have knowledge of: (a) how to display itself within the (time-based) display framework (e.g., calendar page); (b) source(s) and/or destination(s) for communication of data; (c) what information is needed to request an event, and (d) how to display, within the display framework, a dialog for an event request.

As used herein, the terms “module” and/or “engine” may also refer to any of an application-specific integrated circuit (“ASIC”), an electronic circuit, a processor (shared, dedicated, or group) that executes one or more software or firmware programs, a combinational logic circuit, and/or other suitable components that provide the described functionality.

End users may decide which savers to use within the multi-entity event coordination application, and the users may manage that process via a saver store or exchange provided by the system 110. End users may also create savers of people whose calendar they manage, such as a parent creating a saver for a child, or a business creating a saver for an employee. In an exemplary embodiment, a hair salon business owner can create a saver for each of their stylists, since each stylist's calendar of appointments and availability will be different.

The system 110 is configured to utilize a calendar display framework that may include the ability to display events from multiple calendars, schedules, or itineraries (referred to generally herein as “calendars”) at the same time, in a single user interface. A calendar that agglomerates (e.g., presents side-by-side) savers from a plurality of entities is referred to herein as a multi-entity calendar.

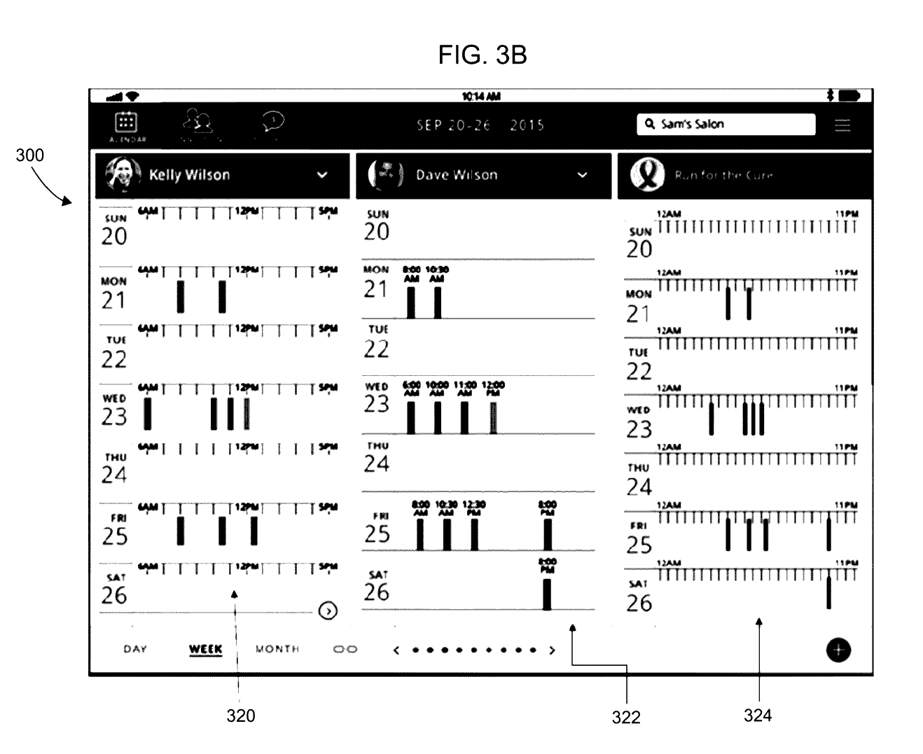

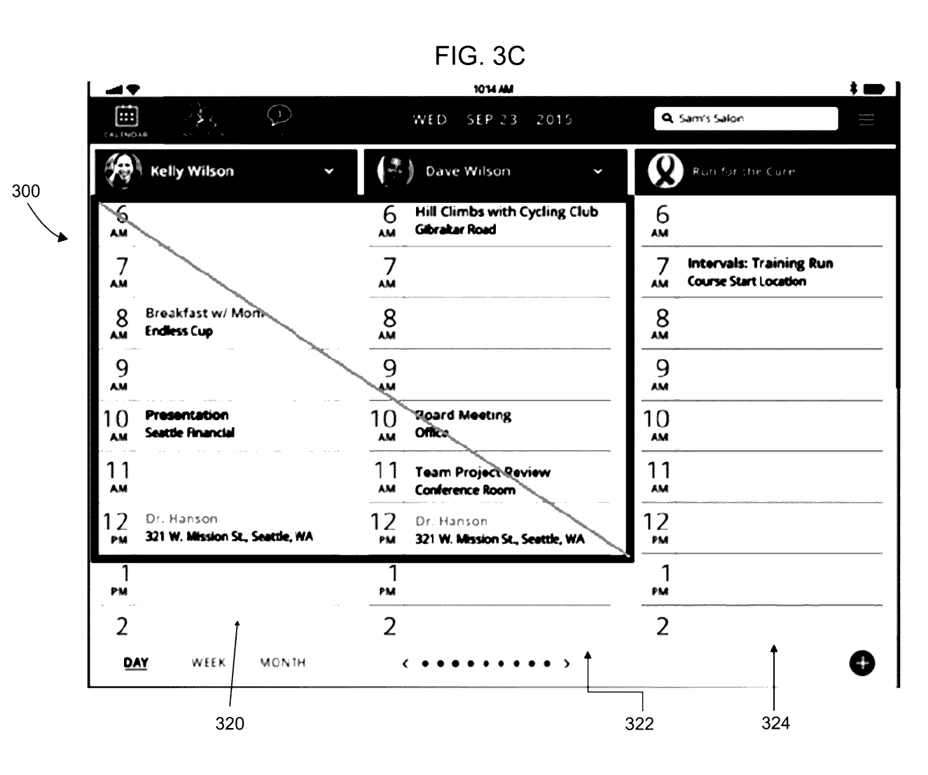

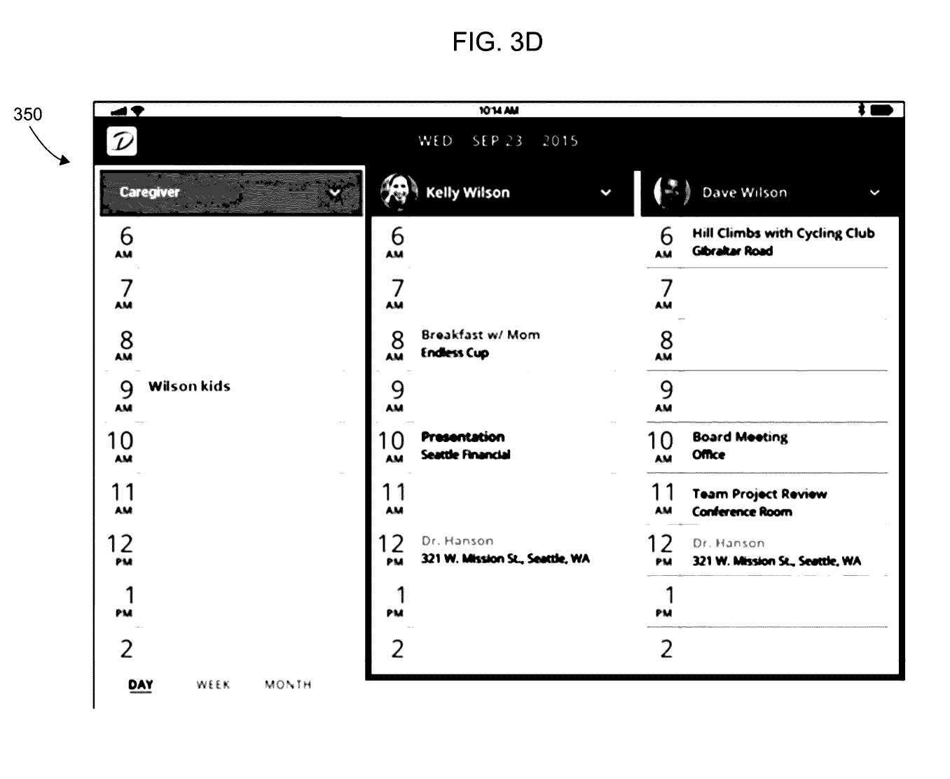

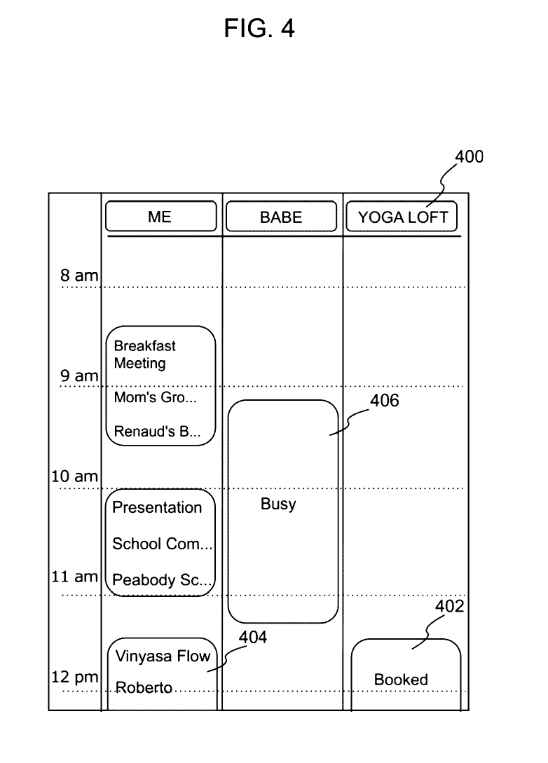

In some cases, particularly where a user may have a shared or referenced calendar with someone like their spouse or child, events may overlap in time. As well, some savers may have uniquely styled displays. Furthermore, the system 110 may be configured to know for which saver one would like to create an event without necessity of a current saver. The calendar display framework may therefore utilize a spreadsheet or matrix format. An exemplary embodiment of such a format is illustrated in FIGS. 3A and 3B, with corresponding general schematic diagrams in FIGS. 2A and 2B.

FIG. 2A is a schematic diagram of the layout for a multi-entity calendar interface where the vertical time dimension represents minutes and hours. FIG. 2B is a schematic diagram of the layout for a multi-entity calendar interface where the vertical time dimension represents days, and the horizontal dimension 206 within each day (row) represents the hours in the day for each saver (column). In the figures, each block of time 202 within a saver may be configured for any number of hours in a day (by day), days in a week (by week), days in a month (by month), or other configurations. Savers are disposed in columnar format. For example, the horizontal axis 204 is divided into columns that each comprises a different saver. In other embodiments, savers may be displayed horizontally with the axis of time 202 being displayed vertically.

Examining the concept in more detail, in an exemplary embodiment, a matrix 200 is populated with savers in a vertical orientation on a smart-phone device, for example. In exemplary embodiments of FIG. 2B, multiple events 206 for a single day may be displayed across each saver 204.

FIG. 3A is an example multi-entity calendar interface comprising a plurality of savers in “day” mode, where each row represents some portion (typically hours) of a day. The exemplary graphical user interface (GUI) 300 of FIG. 3A includes a time axis 302 comprising a time frame spanning from 8 am until 12 pm. To be sure, the scale of the time axis 302 is configurable such that a smaller or larger time frame can be displayed. The GUI 300 also comprises saver columns that extend along the horizontal axis 304. In some embodiments, the GUI is configured to accept gestural input to shrink or expand the time axis 302. The UI can also be configured to accept gestural input to shrink or expand the horizontal axis 304 such that fewer or more savers are displayed in the GUI 300.

The exemplary GUI 300 of FIG. 3A comprises three savers, a ME saver 306, a BABE saver 308, and a YOGA LOFT saver 310. In this embodiment, the ME saver 306 corresponds to a calendar of the user of the client device that is executing the multi-entity event coordination application. The BABE saver 308 corresponds to a family member calendar of the user for the ME saver 306. The YOGA LOFT saver 310 corresponds to a merchant selected by the user for incorporation into their multi-entity calendar. In this example, the user has selected a yoga studio as a merchant saver selection.

For context, the user can request additional savers from other users, such as savers associated with family, friends, business associates, other individuals, merchants, primary care physicians, medical/healthcare patient portals, healthcare organizations and so forth. Users can also add their business calendar to their personal calendar(s). Each user has control over how their one or more savers are shared with others. For example, a user may choose to share a personal calendar with a relative, but not a business calendar. A user may also share certain events or properties of an event with another person, instead of an entire saver or an entire calendar.

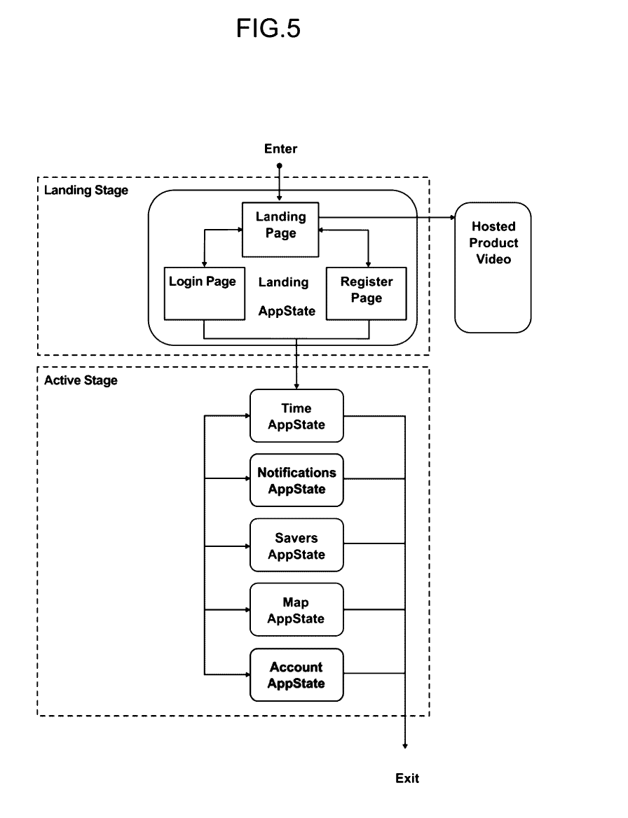

Assuming a user desires to share their saver with another user, in some embodiments, each sharing user can specify security preferences that govern what type of content is displayed when the user's saver is displayed. For example, the entity associated with the BABE saver 308 in FIG. 3A can specify that only a busy message is to be displayed for their calendar entries, as illustrated in the GUI 400 of FIG. 4. The calendar entry 406 now displays “Busy” rather than the flight information as displayed in the GUI 300 of FIG. 3A. The flight information is displayed in the native calendar for the entity associated with the BABE saver 308, on their client device.

The system 110 can be configured to allow a user to share their saver with a plurality of other entities. The user can also configure security preferences for each of the plurality of other entities on an individual basis. Some entities may see all content available for calendar entries, while others see only a “Busy” message or a blocked out time frame. In other instances an entity is allowed to see only certain types of calendar entries. For example, a user can select that only certain types of calendar events are viewable by other entities with which the user has shared their saver. In an example, the user selects that the only calendar events that are viewable by others are work related meeting events. Indeed, the system 110 provides each user with mechanisms, such as GUIs that have selectable security preferences for their savers, those entities with whom they share their savers, and how calendar entries are formatted and/or shared with others. There may be various layers of security and configuration for the aspects of a user's publicly-accessible calendar. Additionally, there can be a different level of sharing capabilities for a user to share aspects of a saver or an entire calendar with other users of the system as opposed to other members of the general public.

Referring back to FIG. 3A, each of the columns comprises calendar events for a respective entity. In the ME saver 306, the column is filled with the user's events that are scheduled in the displayed time frame.

In some embodiments, each column is selectable. When a column is selected, the user can scroll vertically in up or down direction to view additional calendar events for the selected entity. Each of the calendar events, such as calendar event 312 is selectable (if allowed by the security preferences of the entity associated with the saver). Additional content or details can be displayed if available.

Advantageously, the YOGA LOFT saver 310 is a merchant saver. A calendar event, such as event 312, is selectable and comprises an offer for a good or service available to the user. For example, the calendar event 312 comprises an available reservation or available class time for a Vinyasa yoga class offered by the merchant associated with the YOGA LOFT saver 310.

If the user selects this calendar event and chooses to schedule the class, a calendar event (404 of FIG. 4) can be automatically added to the ME saver 306 at the time specified in the original calendar event. Likewise, the calendar event 312 can be selectively changed to read “Booked” (see 402 of FIG. 4). In some embodiments, the calendar event 312 is unchanged after selection and/or scheduling.

The YOGA LOFT merchant 310 can also provide multiple savers, for example a saver for each yoga teacher, or a saver for each room with an exercise class. In this way, a user who wishes to attend a specific class offered at a specific time or room can view availability of that class specifically and take actions such as adding the class to their personal saver, reserving a spot in the class, adding an event notification on their personal device as a reminder, or other similar actions, depending on personal preference and/or sharing settings of the offering merchant. Similarly, if a user wishes to attend a class taught by a specific person, they can view that person's saver at YOGA LOFT 310 to see when that teacher will be leading a class, and take actions such as adding it to their personal saver, reserving a spot in the class, adding an event notification on their personal device as a reminder, or other similar actions.

FIG. 4 also illustrates an example calendar entry 406 that has been modified by a security policy or preference. For example, the BABE user 308 may specify that they desire for the ME user 306 to only see calendar entry 406 as “Busy” rather than displaying the content as illustrated in FIG. 3A.

Mobile devices may have elongated (non-square) displays that may allow the user to orient the display in either a vertical or horizontal format. Laptop displays, desktop monitors and TVs all may have horizontally elongated formats as well.

Additionally, various embodiments may also allow the user to list all events from all savers along a single timeline.

FIG. 3B is an example multi-entity calendar interface comprising a plurality of savers in “week” mode, where each row represents a day and each day of the week is displayed in the matrix. Within each row of each saver, events are displayed horizontally relative to the hours in the day. FIG. 3B specifically illustrates multiple savers 320, 322, and 324 on one dashboard view (GUI 300). Each of the savers in this embodiment displays a week of entries, broken down by days of the week. Each day entry may display a timeline and icons that indicate events scheduled on the timeline. In this way, a user can view saver events in the context of an entire week. Also, in the exemplary embodiment of FIG. 3B, saver 320 belongs to user Kelly Wilson, saver 322 belongs to user Dave Wilson, and saver 324 belongs to an organization Race for the Cure. Viewing all three savers together in one dashboard view (GUI 300) allows the user to quickly see when the events for the organization Race for the Cure 324 are happening, and whether the user has availability or not during those times. In other embodiments, a month view or year view may also be employed in a dashboard format.

In exemplary embodiments, a user may share certain events (even those that span several savers), or properties of an event with another person, instead of sharing a single saver or an entire calendar. The sharing may occur within the multi-entity event coordination application or via a specific file format which would encapsulate the shared information.

FIG. 3C illustrates the selection of multiple events across multiple savers 320 and 322. The events of multiple savers can be combined together and stored as a single saver file that can be shared with third parties. In some instances, the party sharing the combination single saver can set privileges such as read-only, edit, delete, and so forth. In one example, the owner of saver 320 has permission to access the saver 322 of another party. The owner desires to share the combined events of savers 320 or 322 with, e.g., a housekeeper, babysitter, teacher, or other third party. The owner can select the events that he/she desires to share (or even the entire savers) and specify that they are to be combined into a single saver and provided to the third party. More specifically, in the illustrated example, a mother may share some family calendar details with her child's caregiver by selecting a portion of her and her husband's savers (the partial selection of savers 320 and 322 shown in FIG. 3C) to be sent as a single file to the caregiver (third party). FIG. 3D illustrates the view of the combined saver as displayed on another dashboard 350 as would be seen by the third party (i.e., the caregiver in the example). The non-selected saver 324 of FIG. 3C is absent from FIG. 3D because it was not selected for sharing by the owner of saver 320. As such, the third party (e.g., caregiver) can view the calendar details in the third party's own multi-entity event coordination application or at an online viewer or reader. Security sharing permissions would also apply, as discussed herein.

While the embodiments above in FIGS. 3B-D illustrate and describe the display of multiple savers for multiple parties, the present technology can be utilized to display multiple savers for the same entity. In one embodiment, a multi-column format can be used to display various aspects of a travel itinerary.

For example, one columnar saver could be for a commercial cruise line company, where the company may display an itinerary for a particular trip. In one example, a cruise to Alaska may have events for cruise stops along the way, such as in Seattle, Vancouver, and Juneau. Each of these stops has a duration and event descriptive information that can be accessed by clicking on the entry.

Another columnar formatted saver can be added for each of the cruise stops. The saver could include an itinerary of events and activities available at the stop location. The user can select events or groups of events over specified periods of time. The user can also select multiple days over several savers and store these days/events as a single saver. Thus, in this exemplary embodiment, a saver for the cruise trip to Alaska may also include multiple savers within it for events at various stops along the way.

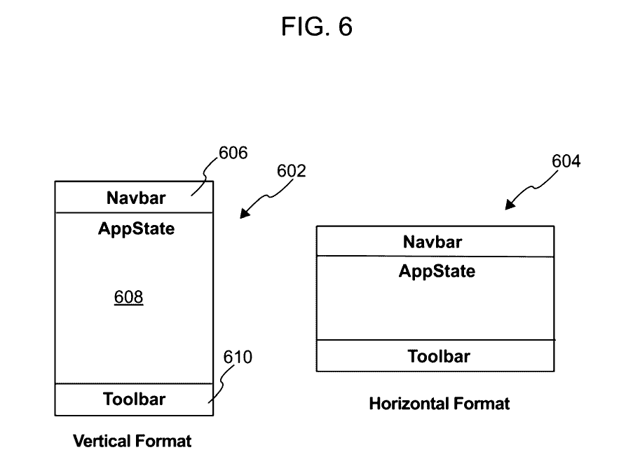

Referring now to FIG. 5, there may be two ways to gain entry into the calendar application. For new users, there may be a registration page and for returning users there may be a login page. For viral adoption of the calendar application, a potential user may be redirected from a partner web-page to the registration page or to an application download site (e.g., Apple App Store, Google Play, etc.) in order to download and install the hybrid application.

Once a user is successfully logged in (Active Stage, in FIG. 5), the application may be considered as being divided into five functional “application states” (each also referred to herein as an “AppState”). The five AppStates may include: (a) Time (T)—the display and management of user specified Savers, and their events, in calendar format; (b) Notifications (N)—the display and management of Saver notifications; (c) Savers (S)—the selection and configuration of Savers, which may include the Saver store; (d) Map (M)—integrated Google Maps for cross-referencing saver events that involve locations; and (e) Account (A)—the management of account settings and application configuration.

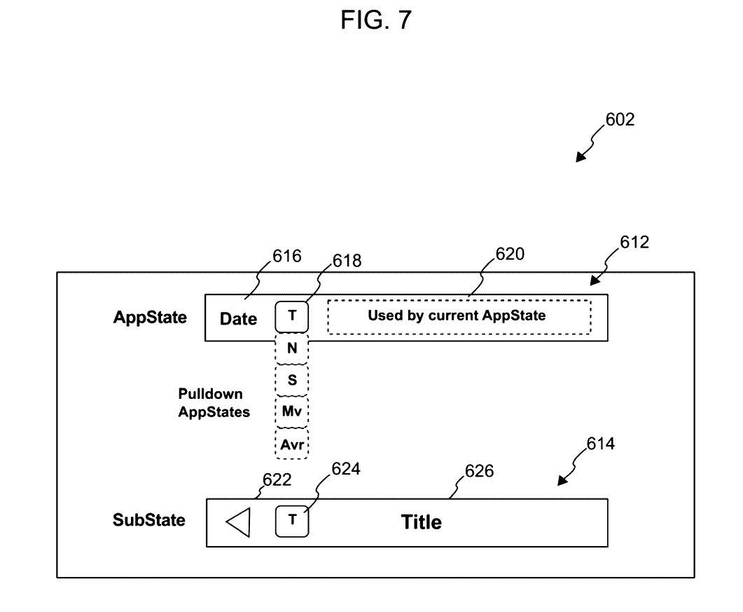

Referring now to FIG. 6, which illustrates an example schematic wireframes for creating a multi-entity calendar interfaces, one in a vertical format 602 and one in a horizontal format 604.

The following schematic wireframes may be applied in a generic mobile device and for purposes of this disclosure do not include any styling, nor look and feel. They illustrate exemplary embodiments of organization, functionality and navigation.

The application GUI, such as the vertical format 602 may be divided into three regions, a navigation bar (Navbar 606), an AppState region 608, and a tool bar 610. The Navbar 606 may include the current date, a list of available AppStates (in a pull-down format or other format), and a region that can be used by the current AppState 608. Whether in a vertical or horizontal format, the Navbar 606 may always be at the top in some embodiments. In other embodiments, the Navbar 606 may be displayed on the bottom or on a side of the user interface. The Navbar 606 may be used to manually navigate between the available AppStates and change (where applicable) any “mode” of the current AppState. The AppState region 608 may be used by the current AppState to display its contents. The tool bar 610 may contain functions associated with the current AppState and may have a mechanism for collapsing/hiding.

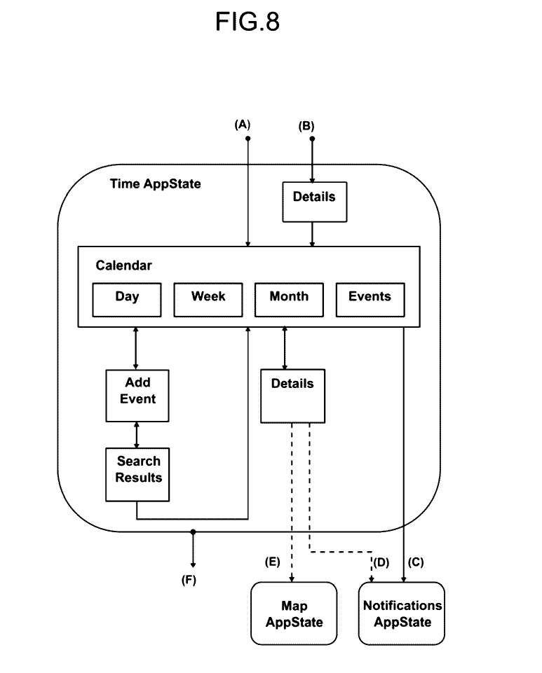

Referring now to FIG. 7, the Navbar 602 may have various configurations, for example, an AppState 612 and a SubState 614 in response to the workflow. The AppState configuration of the Navbar 602, from left to right, may contain the current date 616, a pull-down button of AppStates 618, and a region 620 that is reserved for the current AppState.

The SubState 614 configuration may replace the current date of the AppState configuration with a (triangular) back button 622 used to navigate back up the workflow. It may also contain the pull-down button 624 of AppStates (to show context). The SubState configuration may also display a title 626 for the SubState (or dialog).

The tool bar 610 may include functions pertaining to the current AppState and most particularly to managing information displayed within the AppState region. Depending upon the look and feel, the tool bar 610 may auto-hide/reveal itself and/or have a way for the user to manually hide and reveal the tool bar. The tool bar 610 may also transform (grow/shrink) itself to become the dialog menu for an AppState (e.g., when creating or editing a calendar event).

The landing stage (see FIG. 5) may be the initial AppState the calendar (web or hybrid) application presents to the end-user. If the calendar application can detect that the user is a returning user, then the landing AppState may default to the login page. If not, the application may default to the landing page. The user may easily be able to navigate between the three landing, login and register pages. Note that if the user has simply context switched away from and then back to the application, the application may stay in its previous AppState, even when that is from the active stage.

A registration page may be where a potential new user registers with system 110 by creating a user information saver. The user information required may be commensurate with other software services. Additionally, other non-standard information such as the specification of the potential user's existing digital calendaring solution may be gathered by the calendar application.

When redirected from a partner calendar website to the Registration page, the partner's calendar may be automatically added to the user's system. In some embodiments (not shown above), there may be a graphical representation showing the connection between the partner calendar and the disclosed application in the Registration page.

When a registered user has successfully logged in, the calendar application may transition from a landing state (i.e., Landing AppState) to an active stage (i.e., one of the other AppStates). By default, the Time AppState may be made the current AppState of the active stage.

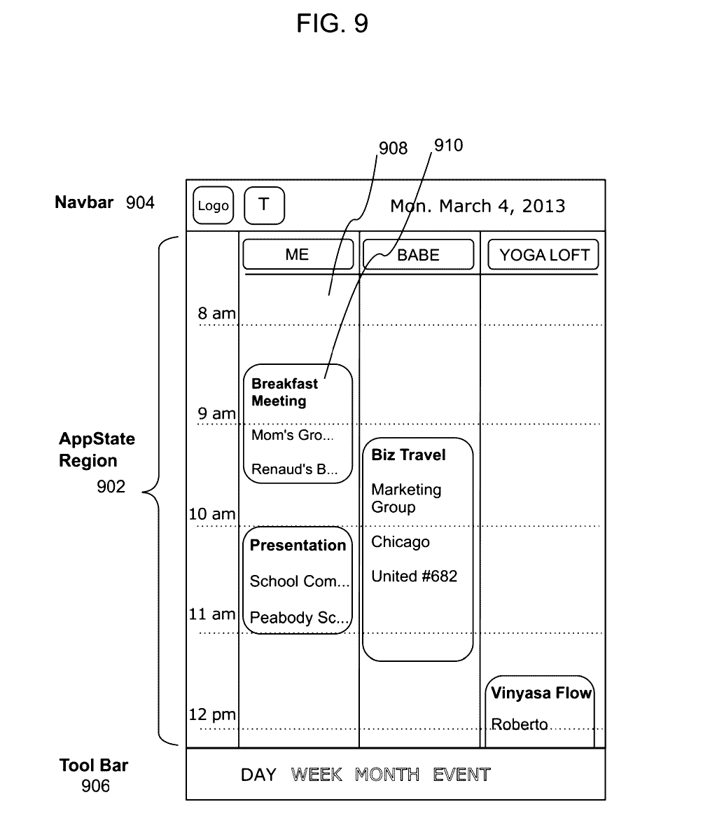

FIG. 8 is an exemplary Unified Modeling Language (UML) diagram for the Time AppState. The Time AppState may be concerned with the display and management of user selected savers (e.g., with their associated events and data)—in a calendar format specified by the calendar application.

The entry point (A) represents when the AppState is entered via the AppState pull-down in the Navbar Entry point; (B) represents when the AppState is entered from the Details SubState of the Notifications AppState Exit point; (C) represents when the AppState is exited from an event in the calendar that has a notifications button the user has clicked Exit point; (D) represents when the AppState is exited via the Details SubState after the user has clicked the “Notify” button (where applicable to the event) Exit point; (E) represents when the AppState is exited via the Details SubState after the user has clicked the “Map Location” button (where applicable to the event); the exit point (F) represents when the AppState is exited via the AppState pull-down in the Navbar. Before exiting, the AppState may save its “state” so that it can be resumed if the next entry is via (A).

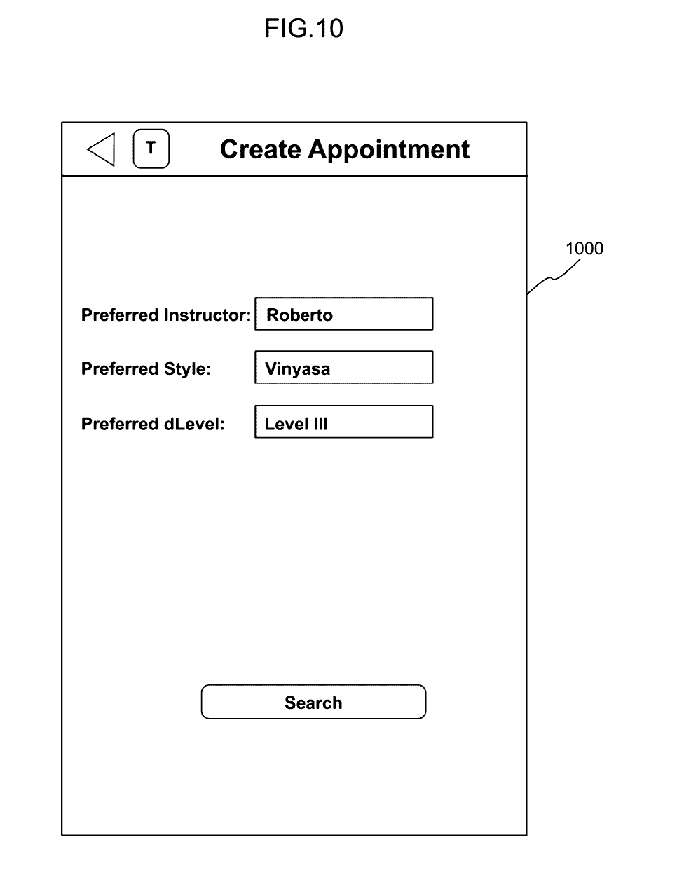

FIG. 9 illustrates an example schematic wireframe for the Time AppState. The AppState specific region 902 of the Navbar 904 may contain the timespan of the current time element and previous and next buttons for changing the current time element.

The tool bar 906 may have buttons used to specify the current time span, which configures the axis of time in the Calendar element.

As mentioned above, there may be a number of user interactions allowed within the calendar display such as swipe and pinch gestures that can be used to change and/or navigate the calendar display. For example, swiping up and down within the left-most column (where the hours may be displayed) may scroll the display of the calendar up and down. The same gesture within a saver column, such as column 908, may select and highlight the specified times. Double-clicking within a saver column may launch the create/schedule event dialog for that saver.

When creating or editing a saver event, such as a calendar event 910, the AppState may transition to a SubState. In displaying a SubState, the SubState version of the Navbar may be used and the content of the AppState region may change to display custom information. The custom information may have already been configured by the user in the Saver AppState, which is described in greater detail infra. In various embodiments, most of the custom information may be represented by pull-down and date-time widgets.

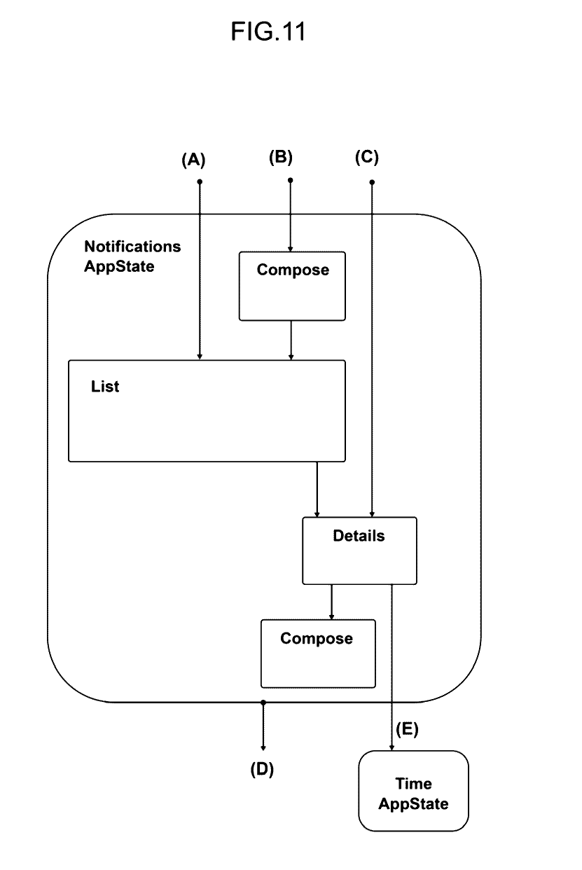

FIG. 10 illustrates an exemplary SubState 1000 for adding an event, such as a calendar event for a saver. In this example, the event is for a merchant, such as a yoga instructor, who wishes to create a calendar of open appointments for yoga sessions. Details regarding which types of data are solicited from a merchant for a good or service can be preconfigured based upon knowledge of the needs of the merchant. For example, an appointment for a restaurant could include a cuisine type, a table number selection, a time, and so forth. In the exemplary embodiment of FIG. 10, a user selects preferred inputs to search for open appointments. The user can then add one of these appointments to his or her own calendar.

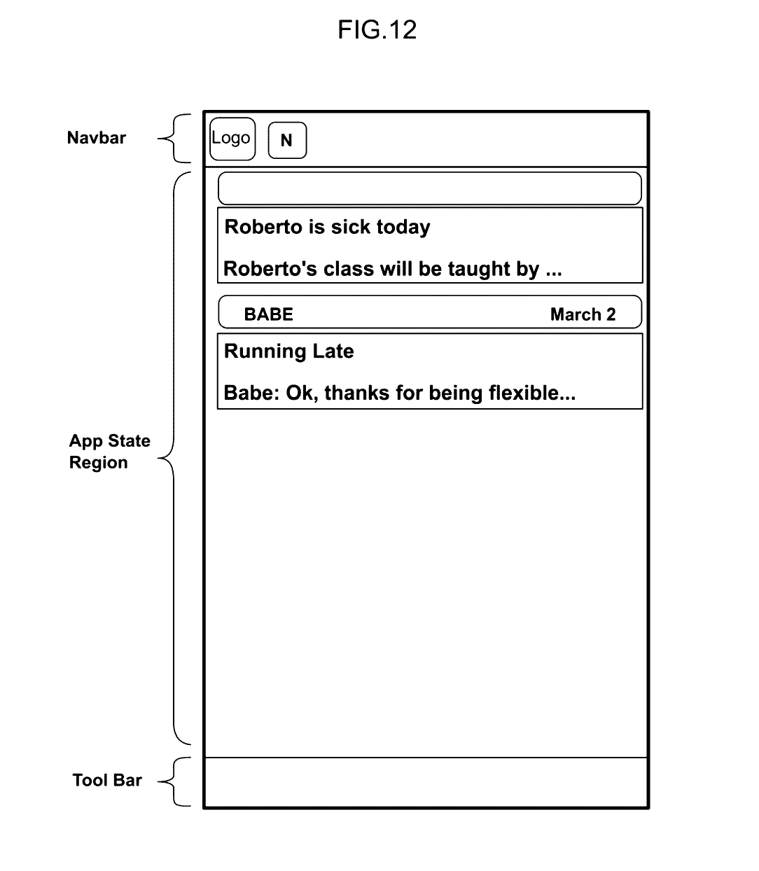

Referring now to FIG. 11, the Notifications AppState may allow the user to visualize all of the notifications that have been sent to, and received by, the user. The Notifications AppState may also allow the user to send a notification or reply to a notification.

The entry point (A) may represent when the AppState is entered via the AppState pull-down in the Navbar. Entry point (B) may represent when the AppState is entered via the Details SubState of the Time AppState, after the user has clicked the “Notify” button (when applicable to an event). Entry point (C) may represent when the AppState is entered from an event in the calendar (Time AppState) that has a notifications button the user has clicked. Exit point (D) may represent when the AppState is exited via the AppState pull-down in the Navbar. The exit point (E) may represent when the AppState is exited via the “Event” button in the Details SubState Before exiting, the AppState may save its “state” so that it can be resumed if the next entry is via (A).

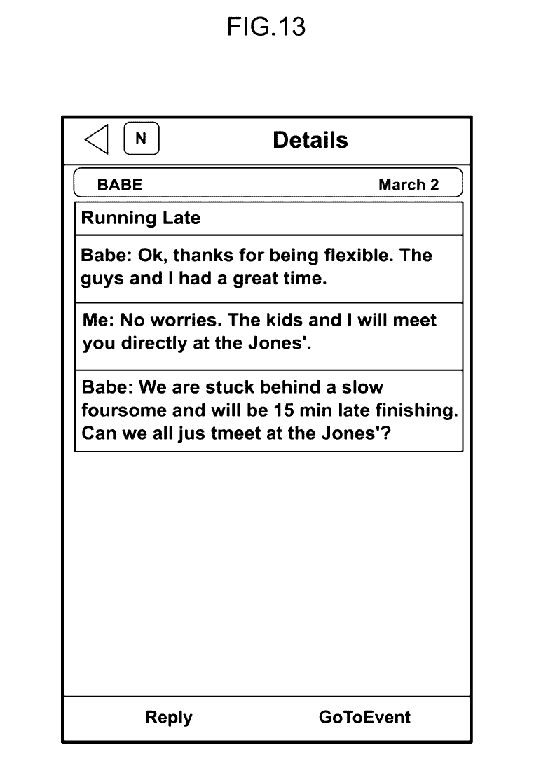

FIG. 12 illustrates an exemplary schematic wireframe for the Notifications AppState. In this wireframe, the merchant can create a notification or message that is transmitted to an entity or multiple entities that have selected a calendar event of the merchant's. For example, user BABE has added a calendar event of Roberto's to their multi-entity calendar interface. When Roberto is unable to attend the event specified in the calendar entry, Roberto can send a notification that he will not be attending the event. Thus, users can message one another regarding calendar events that are shared between the users.

FIG. 13 illustrates an exemplary schematic wireframe for a Details SubState. The Details SubState illustrates a detailed message exchange between users who share a calendar entry. In this example, two users are exchanging messages regarding their ability to make it to the shared calendar event.

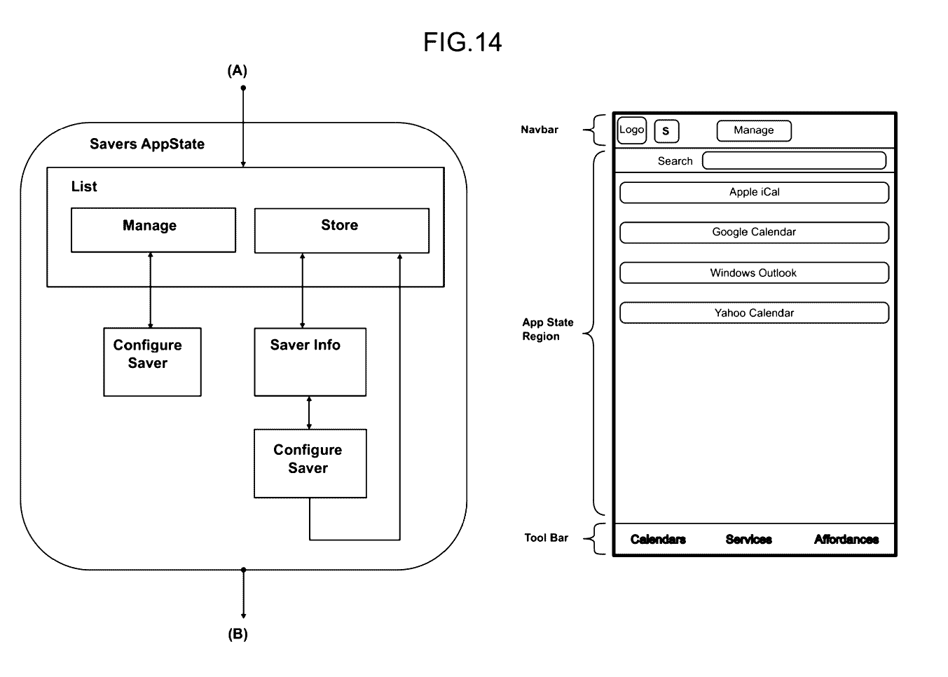

FIG. 14 illustrates an exemplary Unified Modeling Language (UML) diagram for the savers AppState as well as a UI assembled using the UML that allows the user to add or remove savers from their calendar display; to turn on/off (e.g., filter) the UML display for the savers, and to order the saver list.

In an exemplary embodiment, the savers AppState may have two primary modes, such as manage and store, of which one can always be current. The Navbar may include a button bar allowing the user to toggle between the various modes. The manage mode may allow the user (i) to turn on/off the display of installed savers; (ii) to re-configure the default parameters for a Saver; (iii) to change the order in which the savers may be displayed in the time AppState; and (iv) to remove savers from their calendar application account. Fewer or additional options may also be available to the user in the manage mode.

In manage mode, selecting a saver in the list may allow the user to configure the default event creation settings for that saver. Each saver may have its own unique group of attributes or parameters to specify an event. Selecting and vertically dragging a saver in manage mode may reorder the clicked/active saver to where the user positions it relative to the other savers. In other embodiments, a user can specify default parameters to be applied to all of their savers.

The store mode, of which an exemplary embodiment is illustrated in an example UI of FIG. 14, may be where the user can search, learn more about, and add new calendars to their application account. The tool bar may contain a button bar of the three types of Savers. The selected type determines what Savers may be displayed in the AppState region. Fewer or additional types of Savers may also be available in various embodiments.

Selecting a saver may transition the AppState to the saver SubState where the user can learn more about the saver and add it to their calendar application account. This allows the user to see future savers from that entity.

The map AppState may allow the saver to be integrated with a mapping program to cross-reference saver events that involve locations. The mapping program may be GOOGLE MAPS, MAPQUEST, APPLE MAPS, or any other mapping program. The map AppState may allow a user to view various events on their calendar geographically. In some embodiments, selecting a saver may allow the user to view details about the event, including its location on a map. The user can also get directions to that event by car, walking, biking, or public transit. Current traffic information may also be displayed.

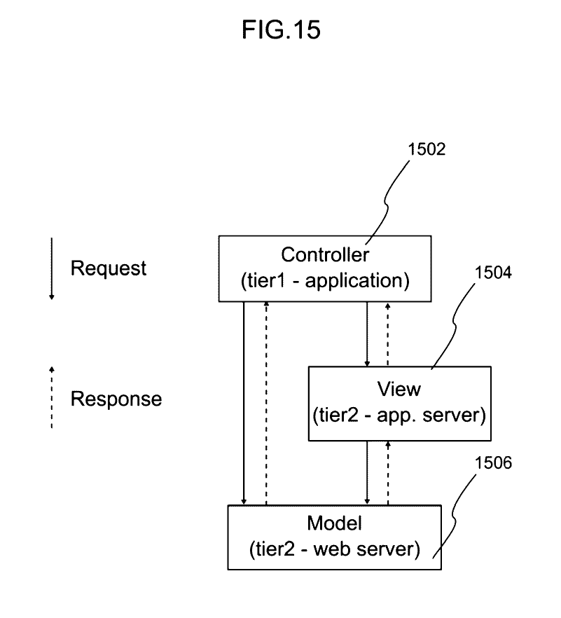

Referring now to FIG. 15, the account AppState may allow a user to manage their account settings and configure applications. The middle-tier web services may include a Representational State Transfer (REST) API to handle requests from the client and return responses. This tier may have two or more distinct functional requirements in some exemplary embodiments. For example, an Integration Application Server as may be required for integrating third party components (such as Microsoft Outlook); and a web server performing specific business logic. Thus, in exemplary embodiments, the web services tier (tier2 see FIG. 1) may actually be composed of two or more separate web services.

The Integration Application Server may process HTTP requests, in turn sending out HTTP requests and processing responses from third party REST APIs, and then format those responses into a document that is consumable by the application. User navigation within the client application may result in new documents being requested, dynamically generated, and/or returned.

The system 110 may also process requests, but may use both REST and/or bi-directional web sockets. The web sockets may, in an exemplary embodiment, be required for saver transactions.

The design of the middle-tier may come from the model-view-controller design pattern. In this instance, the client application (presentation tier) can be thought of as a controller 1502. The application server 1504 may be the view, which returns to the controller the contents of its presentation. The web server 1506 may be the model, which may be a semi-public access layer over the database tier. Results from model requests such as validating a user login may then be used by the controller 1502 to fetch a revised presentation state.

With the exception for the initial requests to the application server 1504 for the login or register landing pages, all HTTP requests for other pages may have the contents of the HTTP request encrypted. All HTTP requests to the web server 1506 may occur over HTTPS or other encrypted transport layers.

Since the calendar application is dealing with private information, security may be important. Security may be especially important when data is sent between the presentation and middle tiers, as well as for gaining access to the middle tier services. Two primary security measures that may be employed in an exemplary embodiment include encrypted communication, and authentication tokens. Other security measures may also be utilized in addition to, or instead of, these two primary security measures.

Unique authentication tokens may also be required for every request to the web server 1506 as well as to the application server 1504 (with the previous exception for Login and Register landing pages). There may be distinct types of tokens in some embodiments such as view tokens for the application server 1504 and model tokens for the web server 1506. A request to the web server 1506 may be required to include a model token. The successful validation and processing of that request may return both the results of the request, plus new view and model tokens. The view token may be sent with an update request to the application server 1504 to get the new presentation contents. When returned, the new presentation contents may contain a new view token to handle any future application server 1504 request due to application navigation. The model token may be used for the next request to the web server 1506. Model and view tokens may have a time duration after which they may be invalid in some embodiments. The tokens may contain information that, among other things, identifies the validated user.

The following is a list of HTTP requests that the application server 1504 may implement. Fewer or additional HTTP requests may also be implemented by the application server 1504 in various embodiments.

In a default operation, the application server 1504 may look for URL parameters in order to decide if the content for the Login or Register page should be returned. This may not require a view authentication token. Along with the page content, the default may return a view token that can be used for any subsequent navigation requests and a model token that can be used for web server 1506 requests (e.g. login requests).

A navigation operation utilizes a view token as well as information pertaining to the navigation request in some embodiments. A view token may also be required to utilize a view token which may represent coded information on what view contents to return. If possible, the three requests may simply be differentiated by URL parameters to a single handler.

The following is a list of HTTP requests (all of which may require a valid model token) that the web server 1506 may implement. Fewer or additional HTTP requests may also be implemented by the web server 1506 in various embodiments.

The HTTP requests can comprise a login request comprising username and password values. Login requests may return new model and view tokens. Another request comprises a register request to receive values for the fields on the registration page. Register requests may return new model and view tokens.

Reauthorization requests may return new view and model tokens when the given model token is close to expiring. A transaction request receives values for the unique saver ID and the saver's specific information required to perform the specified transaction. Transaction requests may return new model and view tokens.

A saver request receives values for the unique Saver ID, such as the function to be applied to the Saver (e.g. add/remove to/from user's saver list and/or edit the saver's default settings).

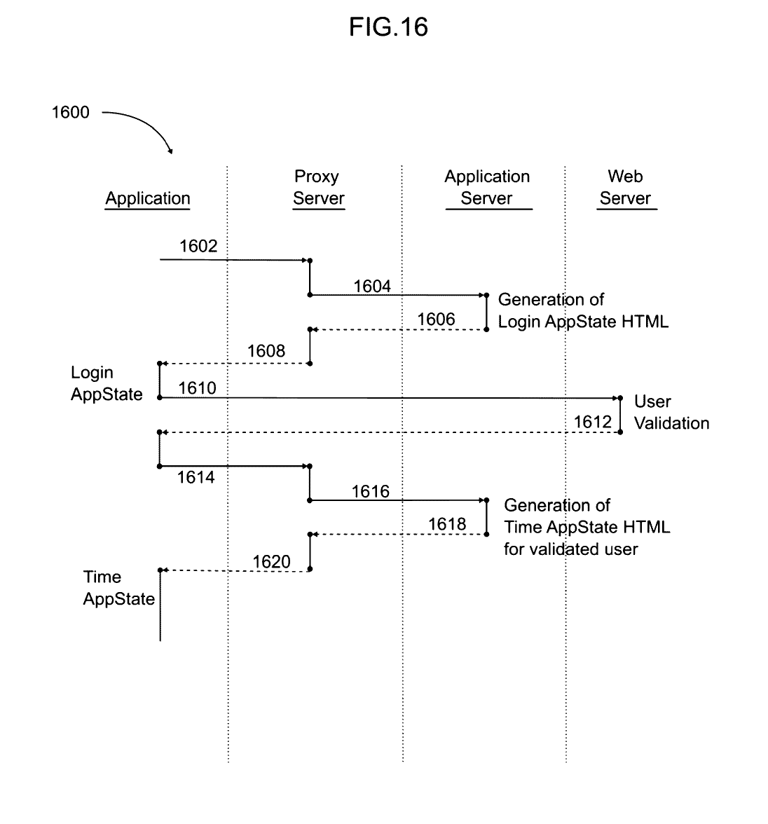

FIG. 16 is a signal flow diagram 1600 of an exemplary login process. When a user opens the application or navigates to the application URL 1602, a proxy server (or load balancer) may pass a URL 1604 to the application server. The application server may determine (e.g., from the fact that there are no URL parameters, which may indicate no View authentication token is present) that the application server should return the Login AppState content. The application server may construct display elements and/or an HTML document for that AppState, generate a new Model authentication token and new View authentication token for that AppState, and return everything to the proxy server 1606. The proxy server may then format the display elements and/or HTML with respect to the device making the request, and may return the resulting display elements and/or HTML 1608 to the requesting browser (or hybrid wrapper). It is noteworthy that the model and view authentication tokens may be generated by and stored in the tier3 database (see FIGS. 1 and 15).

The user may then complete the required fields in the Login AppState and click the login button. This may send a login request 1610 with the Model authentication token and the field's information to the web server. The web server may validate (via the tier3 database) the user's login credentials, generate a View authentication token, and send the results back to the application 1612.

The application may then update itself by sending the View authentication token to the navigation URL (e.g. via a proxy server) 1614, which may then pass it 1616 to the application server. The application server may look up the View authentication token via the tier3 database and determine what AppState and content it needs. The application server may then construct display elements and/or a HTML document for that AppState and content, generate a new Model authentication token and new View authentication token, and return them to the proxy server 1618. The proxy server may then return the resulting HTML to the requester 1620. The user may be then presented with the Time AppState (their calendar).

The database tier may include several databases with cross-referencing between them. The databases may be divided for functionality, execution/query speed, and security reasons. The databases may comprise, for example, a calendar application database and a user content database for storing user accounts, user preferences, and other user data.

The database tier may be a global database used as a librarian. It may have the following tables: (a) User—this table may include a list of all the calendar application users, their names, email addresses, phone number, username and password. It also may have references to their personal content database and a number of statuses about them; (b) Saver—this table may include a list of all the Savers that have been implemented for the calendaring application. This also may include information about the contents of their default parameter page, web addresses to their API, and so forth. These savers may be used by individual users and this table may represent the “saver store”; (c) PaymentSource—this table may include a list of all the payment sources which have been integrated within the calendaring application system. These payment sources can be used by individual users; (c) SecurityTokens—this table may include the active model and view security tokens for querying this database.

In some embodiments, the system can comprise records in a personal content database for each user. Once a user has been validated, everything about that user may be contained in their personal content database. Content databases may be derived from a standardized content template. It may have the following tables: (a) Saver—this table may include a list of all the Savers the user has added to their account along with several statuses about the Saver; (b) SaverEvent—this table may include an entry for each event the user has created for each of their Savers (with the exception of their personal calendar saver, whose events may be stored by that calendar's API); (c) SaverNotification—this table may include an entry for each notification sent or received for each of their Savers; (d) SharedCalendar—this table may include an entry for each other user that this user has shared their calendar with. The entry may include a reference to that user, the sharing level of this user, and whether or not the sharing has been turned off; (e) PaymentSource—this table may include an entry for each payment source added and configured for use by the user; (f) Applicationlnfo—this table may include the user's application information, which may be the values for the various parameters found in the account settings. These affect how the application system interacts with the user; and (g) SecurityTokens—this table may include the active Model and View security tokens for querying this database.

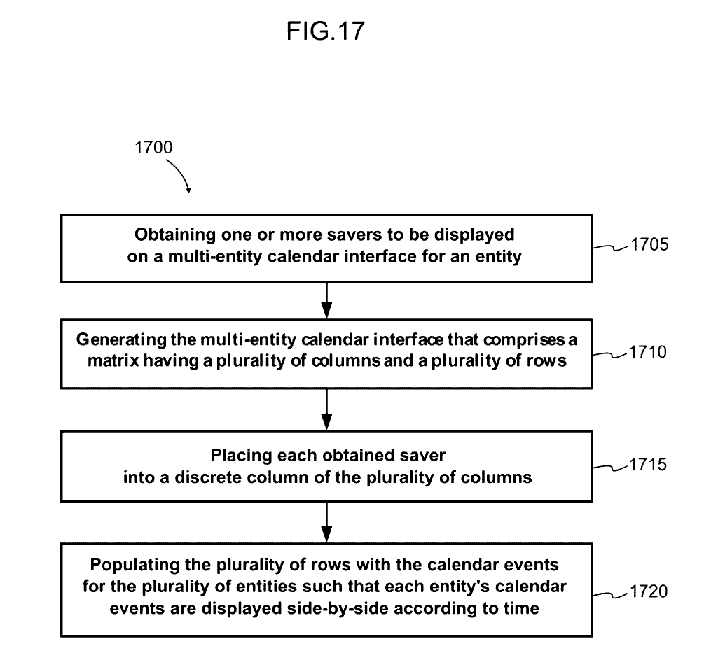

FIG. 17 is a flowchart of an example method 1700 for providing a multi-entity calendar interface. In some embodiments, the method 1700 comprises obtaining 1705 a plurality of savers to be displayed on a multi-entity calendar interface for an entity. Each of the plurality of savers comprises calendar events for one of a plurality of entities.

In some embodiments, the method 1700 further comprises generating 1710 the multi-entity calendar interface that comprises a matrix having a plurality of columns and a plurality of rows. In some embodiments, the matrix is filled by placing 1715 each of the plurality of savers into a discrete column of the plurality of columns. Additionally, the method includes populating 1720 the plurality of rows with the calendar events for the plurality of entities such that each entity's calendar events are displayed side-by-side according to time.

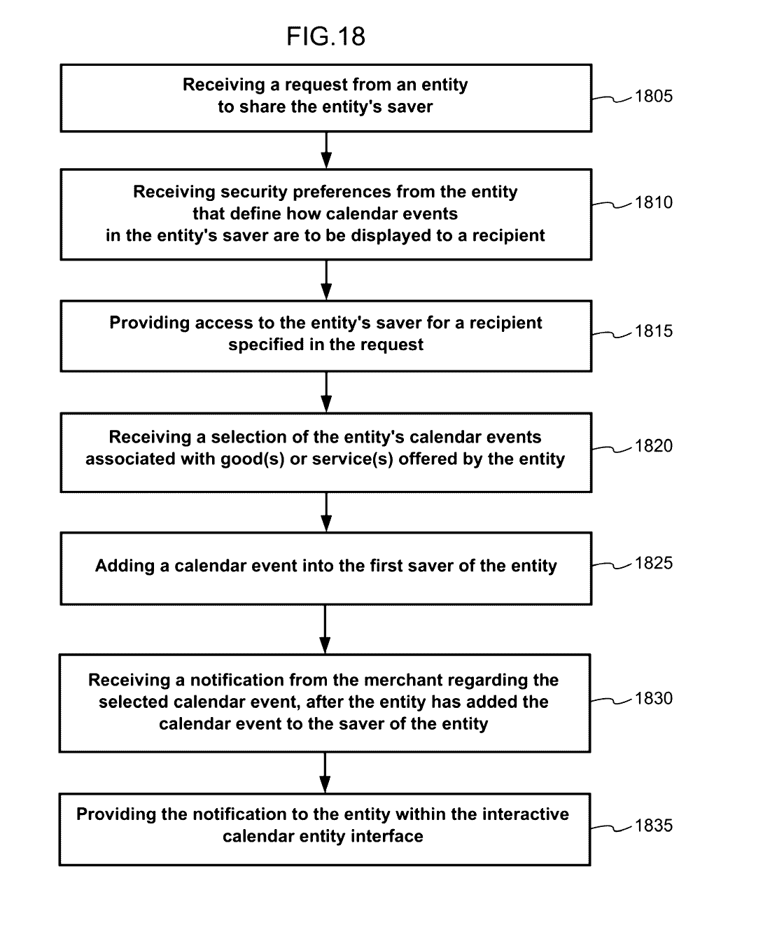

FIG. 18 is a flowchart of an example sub-method 1800 for providing a multi-entity calendar interface. The method 1800 comprises receiving 1805 a request from an entity to share the entity's saver. In some embodiments, prior to sharing the entity's saver, the method includes receiving 1810 security preferences from the entity that define how calendar events in the entity's saver are displayed to a recipient. The method 1800 also comprises providing 1815 access to the entity's saver for a recipient specified in the request.

Again, a shared saver added to the recipient's multi-entity calendar display can comprise a saver for a merchant. The merchant's saver includes calendar events that are associated with a good or service offered by the entity, e.g., for purchase. Thus, the method can include receiving 1820 a selection of the calendar events associated with good(s) or service(s) for sale and adding 1825 a calendar event into the first saver of the entity.

After adding the merchant's calendar event to the saver of the entity, the method can optionally comprise receiving 1830 a notification from the merchant regarding the selected calendar event, after the entity has added the calendar event to the saver of the entity. The method can also include providing 1835 the notification to the entity within the interactive calendar entity interface. The notification may comprise a reminder or information regarding change or update in event information. The notification may be provided as a pop-up message on the user interface, as a text message, email message, instant message, or any other communication method.

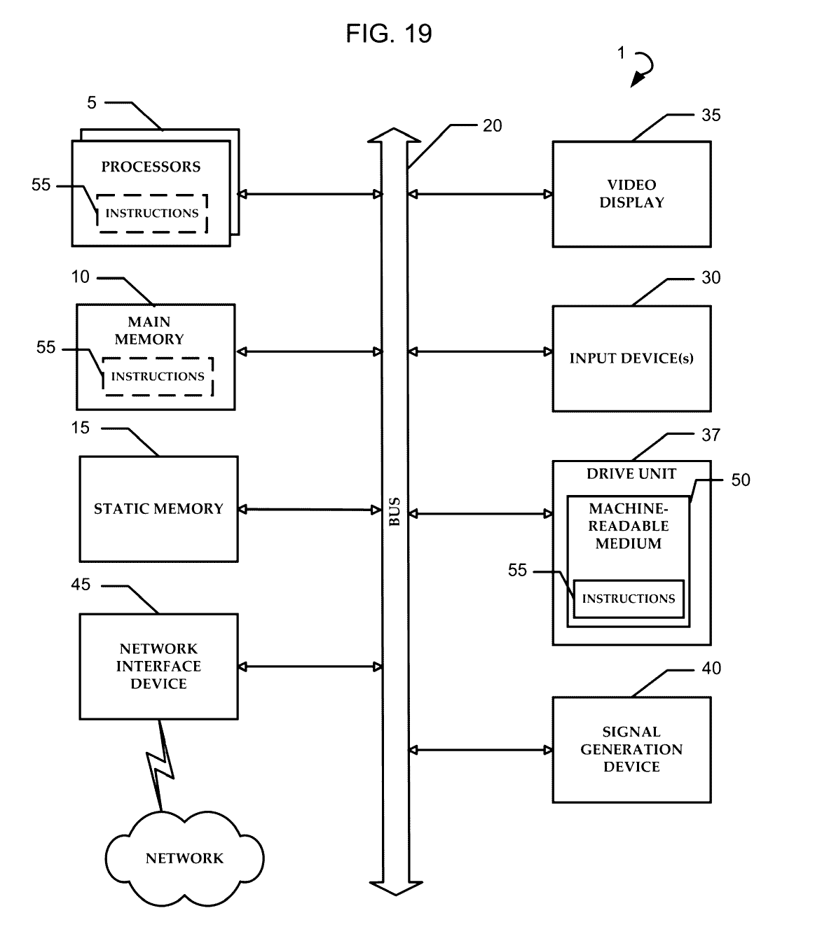

FIG. 19 is a diagrammatic representation of an example machine in the form of a computer system 1, within which a set of instructions for causing the machine to perform any one or more of the methodologies discussed herein may be executed. In various example embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a robotic construction marking device, a base station, a personal computer (PC), a tablet PC, a set-top box (STB), a personal digital assistant (PDA), a cellular telephone, a portable music player (e.g., a portable hard drive audio device such as a Moving Picture Experts Group Audio Layer 3 (MP3) player), a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1 includes a processor or multiple processors 5 (e.g., a central processing unit (CPU), a graphics processing unit (GPU), or both), and a main memory 10 and static memory 15, which communicate with each other via a bus 20. The computer system 1 may further include a video display 35 (e.g., a liquid crystal display (LCD)). The computer system 1 may also include an alpha-numeric input device(s) 30 (e.g., a keyboard), a cursor control device (e.g., a mouse), a voice recognition or biometric verification unit (not shown), a drive unit 37 (also referred to as disk drive unit), a signal generation device 40 (e.g., a speaker), and a network interface device 45. The computer system 1 may further include a data encryption module (not shown) to encrypt data.

The disk drive unit 37 includes a computer or machine-readable medium 50 on which is stored one or more sets of instructions and data structures (e.g., instructions 55) embodying or utilizing any one or more of the methodologies or functions described herein. The instructions 55 may also reside, completely or at least partially, within the main memory 10 and/or within the processors 5 during execution thereof by the computer system 1. The main memory 10 and the processors 5 may also constitute machine-readable media.

The instructions 55 may further be transmitted or received over a network via the network interface device 45 utilizing any one of a number of well-known transfer protocols (e.g., Hyper Text Transfer Protocol (HTTP)). While the machine-readable medium 50 is shown in an example embodiment to be a single medium, the term “computer-readable medium” should be taken to include a single medium or multiple media (e.g., a centralized or distributed database and/or associated caches and servers) that store the one or more sets of instructions 55. The term “computer-readable medium” shall also be taken to include any medium that is capable of storing, encoding, or carrying a set of instructions 55 for execution by the machine and that causes the machine to perform any one or more of the methodologies of the present application, or that is capable of storing, encoding, or carrying data structures utilized by or associated with such a set of instructions 55. The term “computer-readable medium” shall accordingly be taken to include, but not be limited to, solid-state memories, optical and magnetic media, and carrier wave signals. Such media may also include, without limitation, hard disks, floppy disks, flash memory cards, digital video disks, random access memory (RAM), read only memory (ROM), and the like. The example embodiments described herein may be implemented in an operating environment comprising software installed on a computer, in hardware, or in a combination of software and hardware.

Not all components of the computer system 1 are required and thus portions of the computer system 1 can be removed if not needed, such as I/O devices.

It should be noted that as used herein the term “cloud computing” encompasses network-based computing, where computing resources, software and information are provided over the network and are accessible by service providers and/or user devices. User devices may include but are not limited to desktops, PCs, laptops, notebooks, game consoles (e.g., an X-box), music players, tablets, IPods, Smartphones, automobile computer systems, and Internet enabled TVs. A Smartphone may be generally defined as a phone with computing capability. A Smartphone may provide Internet access to an end user.

Some of the above-described functions may be composed of instructions 55 that are stored on storage media (e.g., computer-readable medium). The instructions 55 may be retrieved and executed by the processor. Some examples of storage media are memory devices, tapes, disks, and the like. The instructions 55 are operational when executed by the processor to direct the processor to operate in accord with the technology. Those skilled in the art are familiar with instructions, processor(s), and storage media.

It is noteworthy that any hardware platform suitable for performing the processing described herein is suitable for use with the technology. The terms “computer-readable storage medium” and “computer-readable storage media” as used herein refer to any medium or media that participate in providing instructions to a CPU for execution. Such media can take many forms, including, but not limited to, non-volatile media, volatile media and transmission media. Non-volatile media include, for example, optical or magnetic disks, such as a fixed disk. Volatile media include dynamic memory, such as system RAM. Transmission media include coaxial cables, copper wire and fiber optics, among others, including the wires that comprise one embodiment of a bus. Transmission media can also take the form of acoustic or light waves, such as those generated during radio frequency (RF) and infrared (IR) data communications. Common forms of computer-readable media include, for example, a floppy disk, a flexible disk, a hard disk, magnetic tape, any other magnetic medium, a CD-ROM disk, digital video disk (DVD), any other optical medium, any other physical medium with patterns of marks or holes, a RAM, a PROM, an EPROM, an EEPROM, a FLASHEPROM, any other memory chip or cartridge, a carrier wave, or any other medium from which a computer can read.

Various forms of computer-readable media may be involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU.

The above description is illustrative and not restrictive. Many variations of the technology will become apparent to those of skill in the art upon review of this disclosure. The scope of the technology should, therefore, be determined not with reference to the above description, but instead should be determined with reference to the appended claims along with their full scope of equivalents. While the present technology has been described in connection with a series of embodiments, these descriptions are not intended to limit the scope of the technology to the particular forms set forth herein. It will be further understood that the methods of the technology are not necessarily limited to the discrete steps or the order of the steps described. To the contrary, the present descriptions are intended to cover such alternatives, modifications, and equivalents as may be included within the spirit and scope of the technology as defined by the appended claims and otherwise appreciated by one of ordinary skill in the art.

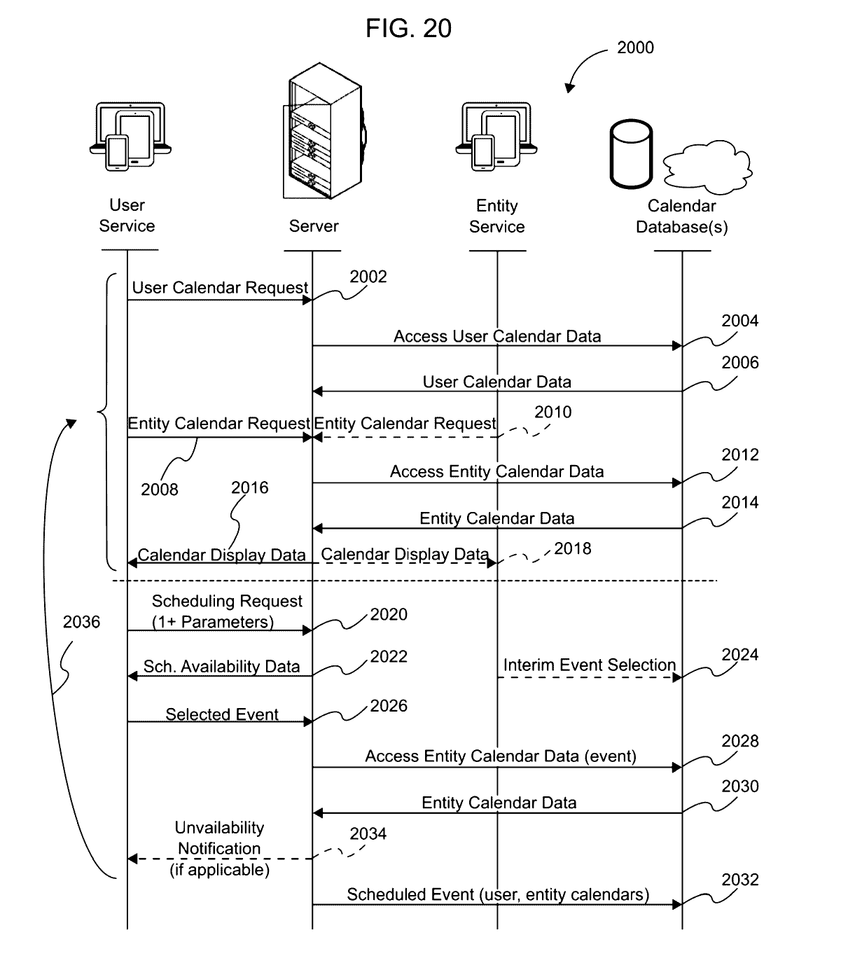

FIG. 20 is a signal flow diagram 2000 for an example multi-entity event coordination system. Devices that may be involved in such signal flow may include a server such as the multi-user calendar web services system 110 or other multi-entity event server such as described herein, one or more user services (e.g., implemented at a user device such as client device 105A), one or more entity servers (e.g., implemented at an entity device such as client device 105B), and one or more calendar databases such as the calendar database 120 described above.

The server may receive from a user service a User Calendar Request 2002 requesting a user calendar. The User Calendar Request 2002 may include user calendar access information such as a user ID, a calendar ID, authentication elements such as username(s) and password(s) and/or other information. With the calendar access information, the server may identify and Access User Calendar Data 2004 at a calendar database to retrieve calendar data associated with the calendar access information. As noted above, the user calendar data may be stored in a calendar database that is local to or co-located with the server, or may be stored at a hosted or third party calendar database remote from the server. For example, the calendar database may include a “cloud” based calendar such as GOOGLE CALENDAR or the like. The User Calendar Data 2006 accessed by the server may be transmitted to the server from the calendar database.

The server may receive and process an Entity Calendar Request 2008, 2010 from a user service and/or from an entity service, similar to the server's handling of the User Calendar Request 2002. For example, the server may Access Entity Calendar Data 2012 at a calendar database based on entity identifying information included with the Entity Calendar Request 2008, 2010 and/or based on predetermined user preferences. Entity Calendar Data is returned 2014 to the server for further processing. As noted above, an entity may be distinct from a user, and Entity Calendar Data may thus be associated with an individual other than the user, with a business, or with a service. The calendar database(s) storing Entity Calendar Data may be distinct from the calendar database(s) storing User Calendar Data, or may be the same depending on implementation. An Entity Calendar Request 2008, 2010 is not necessarily received or processed together with a User Calendar Request 2002.

In some implementations, Calendar Display Data 2016, 2018 may be packaged and delivered by the server based on received User Calendar Data 2006 and/or Entity Calendar Data 2014. The Calendar Display Data 2016, 2018 may be transmitted to the user service and/or the entity service according to where the associated request came from, and may respectively include different data elements based on user and/or entity preferences. For example, the Calendar Display Data 2018 may include all of the requesting entity's calendar events for a requested time period, whereas the Calendar Display Data 2016 may include elements representing the User Calendar Data 2006 and at least elements representing a portion of the Entity Calendar Data 2014. Elements of the Calendar Display Data 2016 that represent the Entity Calendar Data 2014 may in some embodiments include no event data, or a subset of event data from the Entity Calendar Data 2014.

In some implementations the Calendar Display Data 2016, 2018 may include raw data for processing directly by the user service or entity service. In other implementations the Calendar Display Data 2016, 2018 may include a representation of the User Calendar Data 2006 and/or Entity Calendar Data 2014 that can be directly displayed. For example, the Calendar Display Data 2016, 2018 may in some embodiments include data such as HTML code or other browser-interpreted data that can be displayed in a web browser without other processing by the user service or entity service.

Continuing in FIG. 20, elements 2020 through 2036 provide a signal communication flow for a scheduling request by a user of the user service. At element 2020, the user service has already received and presented the Calendar Display Data 2016, permitting the user to view at least a subset of the Entity Calendar Data 2014 in order to schedule an appointment or time.

Scheduling Request 2020 is received by the server from the user service and includes one or more parameters, such as time(s), duration(s), and/or other preferences. For example, as described above, one or more entities may each provide appointments for a variety of services from a variety of providers. The parameter(s) of the Scheduling Request 2020 may thus include a selection of entity, service type, and/or specific provider in some embodiments. It may be noted that each entity may, in some implementations, elect to provide different levels of complexity. For example, one entity may offer a single service from a single provider, thus simplifying the parameters for request. Conversely, an entity may offer many services each corresponding to multiple providers. A hospital, for example, may utilize the service to offer medical appointments for different departments, each department offering multiple services and multiple providers for each of the services. Accordingly, the parameters of the Scheduling Request 202 may be selected from correspondingly detailed menus of parameters. In some implementations, the user may select a subset of available parameters, resulting in a broad response of options to choose from, as discussed further below.

Schedule Availability Data 2022 may be provided from the server to the user service based on the parameters of the Scheduling Request 2020. For example, the Scheduling Availability Data 2022 may include data representing available events, such as appointments, that match the parameters of the Schedule Availability Data 2022. In one non-limiting example, a user may select parameters to request a general appointment (service) with a specific obstetrician (provider) in an obstetrics clinic (entity or sub-entity) on a Tuesday or Thursday (day range) between 1 p.m. and 4 p.m. (time range). Such selection may be made based on a presentation of available periods calculated from the user's own calendar data. The Schedule Availability Data 2022 may provide the obstetrician's availability, if any, matching those parameters. For example, the Schedule Availability Data 2022 may indicate that the obstetrician has two 30 minute appointments available at 1:30 p.m. and 2:15 p.m. on Tuesday. Although the obstetrician may have availability on days or at times that do not match the parameters of the Scheduling Request 2020, such availability may not be presented in response to the Scheduling Request. In some implementations the server may present Suggested Scheduling Availability Data (not illustrated) that is determined based on previous requests, that satisfies a subset of the parameters, or that overlaps with parameters of the Scheduling Request 2020.

The Schedule Availability Data 2022 may be presented via the user service to the user. The user may select an event for scheduling, which Selected Event 2026 is transmitted to the server. The server accesses the Entity Calendar Data 2028 based on the Selected Event 2026 to confirm availability. Entity Calendar Data 2030 is retrieved by the server, which then ensures the Selected Event 2026 is available. If the Selected Event 2026 is still available, the server transmits a Scheduled Event 2032 to the calendar database(s) to update at least one of the user calendar and the entity calendar. If the Selected Event 2026 is not available, e.g., due to an Interim Event Selection 2024 by another user or manual/internal event scheduling, the server may transmit an Unavailability Notification 2034 to notify the user service that the Selected Event 2026 is no longer available. When the Scheduled Event 2026 is confirmed or its unavailability presented, the user's calendar may be refreshed, e.g., by repeating 2036 at least the communication elements 2002 through 2008 and 2016.

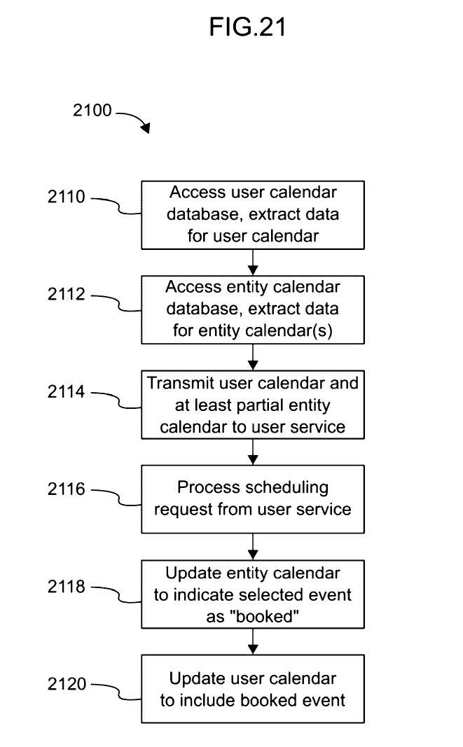

FIG. 21 is a flowchart of an example method 2100 of operating a multi-entity event coordination system according to an embodiment. In Step 2110, a server accesses a user calendar database, and extracts user calendar data corresponding to a user calendar. In Step 2112, the server may similarly access an entity calendar database and extract entity calendar data. The entity calendar data may include, in some embodiments, entity availability from an entity availability calendar and/or scheduled events from a scheduling calendar. In such embodiments the entity availability calendar may include general availability, such as all business hours for a particular entity or provider at the entity. For example, a particular physician at a medical clinic may, in general, be available between 8 a.m. and 5 p.m. on a certain Tuesday. Accordingly, a corresponding availability calendar may represent availability corresponding to such times. Complementarily, an entity scheduling calendar for the physician may include appointments on Tuesday from 8 a.m. to 10:15 a.m. and from 12:30 p.m. to 4:30 p.m. By comparing the availability and scheduling calendars, the server may determine that current availability of the physician is limited to events between 10:15 a.m. and 12:30 p.m. and between 4:30 p.m. and 5 p.m. The entity availability calendar and the scheduling calendar may be separate calendars and may even, in some implementations, be hosted at separate databases.

In Step 2114, the server may transmit elements representing the user calendar and at least part of the entity calendar to a user service, such as a client device, as described in more detail above. In some embodiments, the elements of the entity calendar transmitted to the user service may be limited to an entity name and any events the entity elects to publish generally. In some instances the entity may elect to publish all availability and scheduled event data. Such information may thus be presented with specific event or scheduling detail or it may be identified as “booked” or the like. In other embodiments an entity may elect, or be limited to present only scheduling data that corresponds to a scheduling request from the user service.

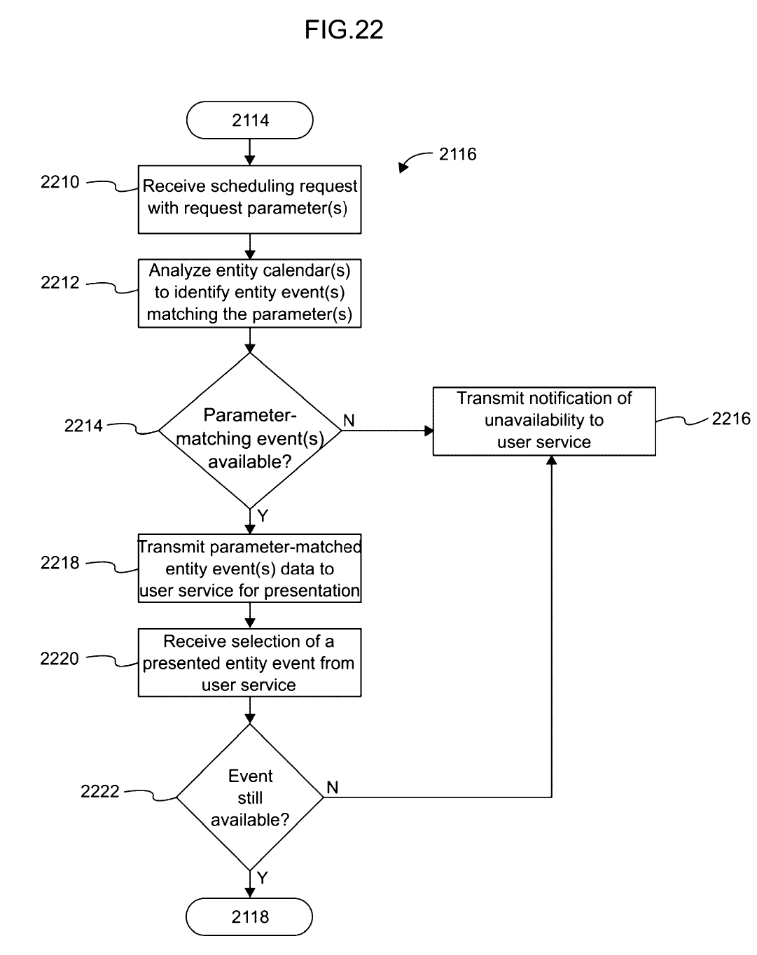

In Step 2116, the server processes a scheduling request received from a user service. This step is discussed in greater detail below with respect to FIG. 22.

In Step 2118 the server updates the entity calendar to indicate that an entity event selected by a user via the user service is scheduled or “booked.” In Step 2120 the server updates the user calendar displayed at the user service to include the scheduled event.

FIG. 22 is a flowchart detailing Step 2116 of FIG. 21. Step 2116 details processing, by the server, of a scheduling request received from the user service. In Step 2210 the server receives a scheduling request that includes one or more request parameters such as the parameters discussed above with respect to FIG. 20. In Step 2212 the server analyzes the entity calendar(s) to identify any entity event(s) that satisfy the request parameter(s). If no entity event(s) are found to satisfy the parameter(s) (“N” in Step 2214), the server transmits a notice of unavailability to the user service to indicate that no entity events were found to satisfy the parameter(s). However, when one or more entity events satisfy the parameter(s) (“Y” in Step 2214), the server transmits (Step 2218) data corresponding to such entity event(s) to the user service for presentation to the user.

At Step 2220 the server receives, from the user service, data representing a selection of an entity event from the parameter-satisfying entity event(s) presented at the user service. At Step 2222 the server checks the entity calendar(s) to ensure the selected entity event remains available, in the event an interim request for the same entity event caused the entity event to become unavailable prior to the user selecting the entity event for scheduling/booking. If not still available (“N” in Step 2222), the server transmits to the user service a notification of unavailability (Step 2216). The notification may include an invitation to try other times. In some embodiments the notification may suggest broadening the scope of the parameter(s), or, as discussed with respect to FIG. 20 above, may present alternative event(s) for potential selection based on previously entered user preferences, user history, analysis of the user's calendar, or the like. However, if the selected entity event remains available (“Y” in Step 2222), the server proceeds to Step 2118 as described above with respect to FIG. 21.

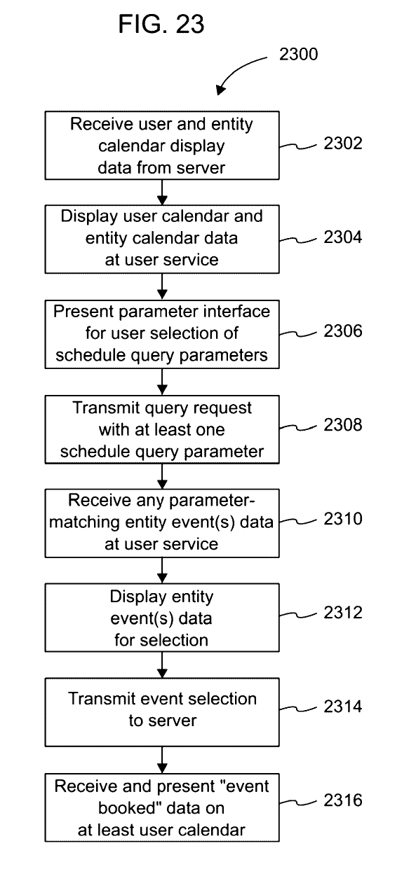

FIG. 23 is a flowchart of an example method 2300 of operating a user service (e.g., client device) of a multi-entity event coordination system according to an embodiment. At Step 2302, the user service receives user and entity calendar display data from an appropriately configured server. At Step 2304 the user service presents, for display, user calendar data and any publicly shared entity calendar data and/or any entity calendar data previously shared by the corresponding entity for presentation via the user service. The user calendar data and the entity calendar data may be displayed in an appropriate time period view, such as a month, week or day view.

The user may elect to schedule an event offered by the entity. In some cases the user may operate a control of the user service to present (Step 2306) a parameter selection interface that permits user selection of schedule query parameters (described in detail above). In Step 2308, the user service transmits a query request to a server, where the query request includes the user-selected schedule query parameters. In response (Step 2310) to the query request, the user service receives data representing entity event(s) data that corresponds to the query parameter(s). If parameter-matching entity event(s) is/are represented in the received response to the query request, the user service displays (Step 2312) the parameter-matching entity event(s) at the user service for review at the user device. The user may select an entity event from among the presented parameter-matching entity event(s). In Step 2314, the user service may transmit the selected entity event to the server. In Step 2316 the user service may receive an indication (e.g., from the server) that the selected parameter-matching entity event is deemed scheduled (or “booked). The indication that the selected entity event is scheduled may be included in the user's calendar or in a calendar displayed at the user service and associated with the entity.

It is acknowledged, and will be appreciated by those having skilled in the art, that elements of the various embodiments described herein may be combined in additional beneficial manners. For example, not every element of a particular device, method or system may be required to achieve the desired structure, functionality or architecture.

According to embodiments, a preferred availability matching (PAM) component of multi-entity event coordination systems reduces the amount of user input and output (I/O) events (e.g., keystrokes, mouse clicks, GUI item selections, voice commands, etc.) to establish an agreed-upon shared calendar event. According to embodiments, the reduced user I/O contributes to decreased average pending invitation latency across a network. According to embodiments, a given computing resource may be optimized (by the use of PAM) to process a larger number of calendar events per cycle, or alternatively a reduced hardware requirement may process an equal number of calendar events per cycle.

In an embodiment, PAM includes one or more algorithms for determining when pairs (or more) of specific entities share common calendar availability and when the common calendar availability meets preferences of the pairs or more of entities. Event selection logic performs functions that were formerly manually performed by users to place proposed events on the user calendars.

In an example, an entity—represented by one or more calendars contained within a Profile—has availability for a given event. The input to PAM contains one or more Profiles, an event description, and a desired time-date range. The event description can represent a duration of time that is less than a day, all-day, be a plurality of days, be repeating, and/or consist of a single occurrence.

In an embodiment, PAM selects a first available calendar duration consistent with each entity's preferences and availability. In an embodiment, PAM selects no calendar event for an entity pair if preference and availability criteria are not met.

In an embodiment, PAM aggregates a proposed calendar matrix (referred to as outDayList below) as data carried by a non-transitory computer readable medium. The proposed calendar matrix caches PAM-generated calendar events for a plurality of at least pairs of users.

PAM outputs zero or more “potential” events that match for all inputs.

Calendars are primarily time-based, but their contained events may also include location. A “Timeplace” variable carries values for time and, optionally, location. Embodiments may track both time and location or time only. Embodiments of PAM may determine availability for an event using a single profile, or using a plurality of profiles.

Events may be defined as three duration values—pre-event duration, event duration, and post-event duration. Pre-event duration can be the amount of personal time a user, a service provider, and/or event host needs to prepare right before an event, for example. Event duration can be the amount of time the user, service provider, and/or event host will spend with one or more other user(s), service receiver(s), and/or event attendees. Post-event duration can be an amount of time a user, service provider, event host, service receiver, and/or event attendee needs to follow-up after the event before a second event or pre-event therefor can be scheduled to begin without a conflict.

Duration values may be used differently depending upon a role for a given Profile. For a service provider (or event host), for example, the total duration of the event may be a sum of all three (pre-event, event, and post-event) duration values. For event attendees, for example, the total duration of an event may be the event (not pre-event and not post-event) duration. In an embodiment, PAM takes the role of the Profile into consideration when determining potential event times.

In embodiments, PAM determines potential times (and optionally, locations) when a given event can be scheduled for a Profile. This is different than a scenario where a Profile has pre-defined, fixed potential event times (such as group events). The algorithm determines, from the input parameters, what potential event times are still available and have not been previously booked. In an embodiment, PAM can populate pre-defined fixed events into user calendars and/or automatically schedule events around such pre-defined fixed events.

The schedule availability of a user Profile (e.g., “free time”) may be determined by the times in which there is not an event already scheduled in a calendar. Previously scheduled events block or take away from availability. In one embodiment, a user may set its Profile to select all available time as whenever there is not a scheduled event. In another embodiment, a user Profile may define its availability by having an “Availability” calendar. In an embodiment, an Availability calendar may include events with the name “Available” that define the limits (time-date ranges) of that Profile's availability. When PAM processes a Profile that has an Availability calendar, then the potential events PAM computes for that Profile are limited to be within the time (and optionally, location) confines of Available events within its Availability calendar.

According to an embodiment, PAM processes event scheduling in two steps. In one step, for a Profile or each of a list of Profiles, event description, date-time range, and optionally location: determine all potential events. This is referred to as “Compute Potential Events.” In another step, for a Profile or a list of Profiles, event description, and start time (from a selected potential event), and optionally location: determine if the event is still available. This is referred to as “Validate Potential Event.”

### Examples

The following is an outline of a PAM algorithm in pseudo-code, according to an embodiment. All date-time comparisons are done in UTC (Universal Time Coordinated). Variables store values. Variables prefaced with “in” represent input variables, variables prefaced with “out” represent output variables, and variables prefaced with “tmp” represent storage for temporary, intermediary values used in logic and computation.

The pseudo-code is an assembly of functions, each prefaced with “func” that receive zero or more input and/or output variables defined with open “(“and close”)” parenthesis and whose scope, like their internal logic scopes, are defined with open “{” and close “}” squiggly braces.

The double back-space “//” represents comments following to its right.

```
------
inProfile - input Profile encapsulating one or more calendars
inEventDescr - input event description
// inTimeRange defines a start day and end day, and a start time and end time within each day.
// inTimeRange may also specify that some days in the range (e.g. weekend days) not be included
inTimeRange - input date-time range within which potential events are to be sought
outDayList - result list of potential events organized by day
funcPAM( inProfile, inEventDescr, inTimeRange, outDayList )
{
      FOR( each valid day tmpDay in inTimeRange )
      {
            tmpSkipDay = false // this will be set to true if there is a blocking all-day event
            tmpPotentialEvents = empty // contains computed potential events for tmpDay
            IF( inProfile uses an availability calendar )
            {
                  funcComputePotentialEventsForDayFromAvailability( inProfile, tmpDay, ...,
            tmpPotentialEvents, tmpSkipDay )
            }
            ELSE
            {
                  funcComputePotentialEventsForDay( inProfile, tmpDay, ..., tmpPotentialEvents,
tmpSkipDay )
            }
            IF( tmpSkipDay equals false AND tmpPotentialEvents is not empty )
            {
                  Add tmpPotentialEvents to outDayList
            }
      }
      // All potential events are in outDayList
}
```

Embodiments of two supporting functions from the pseudo-code above can receive a number of input variables including inProfile. The supporting functions can compute two output variables for output back to the main program. The supporting functions, and their supporting functions, are presented in pseudo-code below.

```
funcComputePotentialEventsForDay( inProfile, inDay, ...., outPotentialEvents, outSkipDay )
{
      tmpAvailableSpanStartTime = start time of inTimeRange
      tmpAvailabileSpanEndTime = end time of inTimeRange
      tmpProfileEventDuration = duration of inEventDescr for inProfile
      tmpExistingEvents = empty // these are existing events which will block availability
      funcGetAllProfileEventsForTimespan( inProfile, inDay, ..., tmpExistingEvents )
      FOR( each event tmpEvent in tmpExistingEvents )
      {
            IF( tmpEvent is an all-day event)
            {
                  outSkipDay = true
                  RETURN // this day needs to be skipped due to an existing all-day event
            }
            ELSE IF( the start time of tmpEvent is before tmpAvailableSpanStartTime )
            {
                  IF( end time of tmpEvent is after tmpAvailabileSpanStartTime )
                        tmpAvailableSpanStartTime = end time of tmpEvent
            }
            ELSE
            {
                  // Timespan( beginTime, endTime )
                  tmpAvailableTimeSpan = Timespan( tmpAvailableSpanStartTime, start time of
tmpEvent )
                  IF( duration of tmpAvailableTimeSpan >= tmpProfileEventDuration)
                  {
                        // potential events within tmpAvailableTimeSpan
                        tmpSpanPotentialEvents = empty
                        funcComputeSpanPotentialEvents( tmpAvailableTimeSpan, ...,
                  tmpSpanPotentialEvents)
                        Add tmpSpanPotentialEvents to outPotentialEvents
                  }
            }
      } // end FOR
      // There may be another time span to check for potential events
      IF( tmpAvailableSpanStartTime is before tmpAvailableSpanEndTime AND
          Duration( tmpAvailableSpanStartTime, tmpAvailableSpanEndTime) >=
tmpProfileEventDuration )
      {
            tmpAvailableTimeSpan = Timespan( tmpAvailabileSpanStartTime,
tmpAvailableSpanEndTime)
            tmpSpanPotentialEvents = empty
            funcComputeSpanPotentialEvents( tmpAvailableTimeSpan, ..., tmpSpanPotentialEvents)
            Add tmpSpanPotentialEvents to outPotentialEvents
      }
}
// Note that the function below does not retrieve events from the Availability Calendar, if it exists
funcGetAllProfileEventsForTimespan( inProfile, inDay, inTimeRange, ..., outEvents )
{
      // This function retrieves all existing events (sorted by start time) within inTimeRange of inDay
      // for the given Profile inProfile. All-day events are sorted to the start of the list.
      // It does so by calling one or more APIs from the
      // calendar platform(s) used by the Profile. No pseudo-code necessary.
}
funcComputeSpanPotentialEvents( inAvailableTimeSpan, inEventDescr, ..., outSpanPotentialEvents)
{
      // inProfileEventDuration is tmpProfileEventDuration variable from caller
      WHILE( duration of inAvailableTimeSpan >= inProfileEventDuration )
      {
            valNewPotentialEvent = create new event from input variables
            Add valNewPotentialEvent to outSpanPotentialEvents
            Add duration of inProfileEventDuration to start time of InAvailableTimeSpan
      }
}
funcComputePotentialEventsForDayFromAvailability( inProfile, inDay, ..., outPotential Events,
outSkipDay )
{
      tmpAvailableSpanStartTime = start time of inTimeRange
      tmpAvailabileSpanEndTime = end time of inTimeRange
      tmpProfileEventDuration = duration of inEventDescr for inProfile
      tmpAvailabilitySpans = empty // these are spans of availability within inTimeRange
      funcGetAllProfileAvailabilityForTimespan( inProfile, inDay, inTimeRange, ..., tmpAvailabilitySpans)
      FOR( each tmpTimespan in tmpAvailabilitySpans )
      {
            IF( duration of tmpTimespan >= tmpProfileEventDuration )
            {
                  funcComputePotentialEventsForDay( inProfile, inDay, tmpTimespan, ...,
outPotential Events, outSkipDay )
                  IF( outSkip Day equals true )
                  {
                        RETURN
                  }
            }
      } // end FOR
} // end func
funcGetAllProfileAvailabilityForTimespan( inProfile, inDay, inTimeRange, ..., outAvailabilitySpans)
{
      // This function gets all the events named “Available” from the calendar named “Availability”
      // associated with the given profile inProfile. These events, clipped to the time range of
      // inTimeRange, become the Availability Spans.
}
```

While various aspects and embodiments have been disclosed herein, other aspects and embodiments are contemplated. The various aspects and embodiments disclosed herein are for purposes of illustration and are not intended to be limiting, with the true scope and spirit being indicated by the following claims.

What is claimed is:

1. A computer server comprising a processor, memory, and communication transceiver, the computer server configured to:
receive, via the communication transceiver, a calendar request for user calendar data associated with a user, the request including at least calendar access information;
access the user calendar data in a first calendar storage based on the calendar access information, the user calendar data including zero or more user events;
access entity calendar data associated with an entity other than the user, the entity calendar data located at a second calendar storage, the entity calendar data including zero or more entity events;
transmit, via the communication transceiver, elements representing the user calendar data and at least a portion of the entity calendar data for simultaneous display at a user service;
receive, via the communication transceiver from the user service, a scheduling inquiry, the scheduling inquiry including one or more request parameters, the one or more request parameters including at least one of: an entity identifier, a date, a start time, an end time, an event type, and an entity event resource;
identify, via the processor, as a potential entity event each of the entity events that is available and that satisfies the one or more request parameters of the scheduling inquiry;
transmit, via the communication transceiver to the user service, each potential entity event;
receive from the user service a selection communication identifying a selected entity calendar event from among the potential entity event that satisfy the one or more request parameters;
update the entity calendar data to show the selected entity calendar event as no longer available; and
update the user calendar data to show the selected entity calendar event.

2. The computer server of claim 1, wherein the first calendar storage is a third-party database.

3. The computer server of claim 2, wherein the third-party database is remote from the computer server.

4. The computer server of claim 1, wherein the first calendar storage is a cloud-based database.

5. The computer server of claim 1, wherein the entity calendar data includes booked event data and availability data, the entity events are included in at least the availability data, and the entity events are also included in the booked event data if they have been reserved.

6. The computer server of claim 5, wherein the booked event data corresponds to a booked event calendar and the availability data corresponds to an entity availability calendar.

7. The computer server of claim 6, wherein the entity availability calendar includes time periods identified as available and the booked event calendar includes time periods that are reserved and not available.

8. The computer server of claim 7, wherein the time periods that are reserved overlap one or more of the time periods identified as available.

9. The computer server of claim 1, wherein the entity calendar data is accessed based on the calendar access information.

10. The computer server of claim 1, wherein the second calendar storage is a third-party database.

11. The computer server of claim 10, wherein the first calendar storage and the second calendar storage are co-located.

12. The computer server of claim 1, wherein the second calendar storage is a cloud-based database.

13. The computer server of claim 1, wherein to transmit the elements representing the user calendar data and the at least a portion of the entity calendar data is performed according to a predetermined timetable.

14. The computer server of claim 1, wherein the user calendar data and the at least a portion of the entity calendar data are transmitted according to a refresh setting.

15. The computer server of claim 14, wherein the refresh setting is selectable from one or more refresh periods or from a push transmission that is triggered by a change in at least one of the user calendar data and the at least a portion of the entity calendar data.

16. The computer server of claim 1, wherein a duration is calculated from the start time and the end time.

17. The computer server of claim 1, wherein the entity identifier corresponds to the entity calendar data.

18. The computer server of claim 1, wherein the event type is selectable from a list of event types.

19. The computer server of claim 18, wherein the list of event types corresponds to distinct categories of service provided by the entity.

20. The computer server of claim 19, wherein the list of event types is provided in the entity calendar data.

21. The computer server of claim 1, wherein the entity event resource is selectable from a list of one or more resources.

22. The computer server of claim 21, wherein the list of one or more resources identifies a service provider person.

23. The computer server of claim 1, wherein to identify the potential entity event includes to identify events from the entity calendar data that are available and that do not conflict with the user events already found in the user calendar data.

24. The computer server of claim 23, further comprising: if no available entity events are identified that satisfy the one or more request parameters, transmit an indication of unavailability to the user service.

25. The computer server of claim 1, further comprising: if no available entity events are identified that satisfy the one or more request parameters of the scheduling inquiry, analyze the client calendar data and the entity calendar data for identification of an entity events that matches a subset of the of the one or more request parameters.

26. The computer server of claim 1, further comprising: if no available entity events satisfy the one or more request parameters of the scheduling inquiry,
analyze the client calendar data and the entity calendar data for identification of an entity event that matches an expanded parameter corresponding to one of the one or more request parameters.

27. The computer server of claim 1, further comprising:
access again the entity calendar data; and
check that the selected entity calendar event is still available, wherein
to update the entity calendar data is dependent on the selected calendar event being available at the time of the update.

28. The computer server of claim 27, further comprising: if the selected entity calendar event is not still available, transmit an indication of unavailability to the user service.

29. A schedule coordination server having circuitry configured to:
retrieve, from a first electronic schedule storage, a schedule of a first entity;
retrieve, from a second electronic schedule storage, a schedule of a second entity;
provide to a device of the first entity elements representing at least a portion of the schedule of the first entity and at least a portion of the schedule of the second entity;
electronically receive, from the device of the first entity, a scheduling inquiry to identify a mutually available event time associated with an event offered by the second entity, the scheduling inquiry including scheduling parameters for identifying a mutually available event time;
identify a set of first entity events in the schedule of the first entity that intersect with the scheduling parameters;
identify a set of second entity events in the schedule of the second entity that intersect with the scheduling parameters;
calculate availability time spans for the second entity that satisfy the scheduling parameters, that do not conflict with the set of first entity events, and that do not conflict with the set of second entity events;
provide the calculated availability time spans for display at the device of the first entity;
receive from the first entity a selection identifying one of the presented time spans; and
update the schedule of the first entity and the schedule of the second entity to indicate that the one of the presented time spans is associated with a scheduled event.

30. The schedule coordination server of claim 29, wherein the scheduling parameters of the scheduling inquiry comprise a date range start date and a date range end date, and wherein the set of first entity events and the set of second entity events are events that each end on or after the date range start date and begin on or before the date range end date.

31. The schedule coordination server of claim 30, wherein the scheduling parameters of the scheduling inquiry further comprise an appointment range start time and an appointment range end time, and wherein first entity events and second entity events that intersect with the scheduling parameters are existing events that, for a date within the date range start date and the date range end date, end after the appointment range start time and that start before the appointment range end time.

32. A method for electronically reserving a mutually available event, the method comprising:
receiving a scheduling availability inquiry from a first entity, the scheduling availability inquiry including limiting parameters, the limiting parameters including at least a requested start date, a requested end date, and a requested event duration;
identifying, in a first entity electronic calendar, all available time periods from the requested start date through the requested end date that have the requested event duration;
generating presentation elements corresponding to a portion of the first entity electronic calendar for perceptibly indicating the identified available time periods;
receiving a selection of one or more of said any available time periods, and an identity of a second entity;
identifying in a second entity electronic calendar any second entity events that are available and correspond to the selection of one or more of said any available time periods;
generating display elements corresponding to a portion of the second entity electronic calendar and including the identified any second entity events;
receiving a first entity event selection of one of the identified second entity events;
updating the first entity electronic calendar to include the one of the identified second entity events from the first entity event selection; and
updating the second entity electronic calendar to indicate as reserved the one of the identified second entity events from the first entity event selection.

33. The method of claim 32 wherein the first entity electronic calendar is located in a third-party database, and further comprising:
accessing the first entity electronic calendar in the third-party database.

34. The method of claim 32, wherein the second entity electronic calendar is located in a third-party database, and further comprising:
accessing the second entity electronic calendar in the third-party database.

35. The method of claim 32 further comprising:
before updating the first entity electronic calendar and the second entity electronic calendar, ensuring the selected one of the identified second entity events is still available in the second entity electronic calendar.

36. The method of claim 32, wherein the limiting parameters further include at least one of an event start padding duration and an event end padding duration, the event start padding duration defining a period before the requested event duration and the event end padding duration defining a period of time after the requested event duration, and
the identifying of all available time periods includes identifying available time periods of the requested event duration plus the at least one of the event start padding duration and the event end padding duration.

37. A computing apparatus, comprising:
a processor;
a communication transceiver; and
a memory storing instructions that, when executed by the processor, configure the apparatus to:
receive a scheduling availability inquiry from a first entity, the scheduling availability inquiry including limiting parameters, the limiting parameters including at least a requested start date, a requested end date, and a requested event duration;
identify, in a first entity electronic calendar, all available time periods from the requested start date through the requested end date that have the requested event duration;
generate presentation elements corresponding to a portion of the first entity electronic calendar for perceptibly indicating the identified available time periods;
receive a selection of one or more of said any available time periods, and an identity of a second entity;
identify in a second entity electronic calendar any second entity events that are available and correspond to the selection of one or more of said any available time periods;
generate display elements corresponding to a portion of the second entity electronic calendar and including the identified any second entity events;
receive a first entity selection of one of the identified second entity events;
update the first entity electronic calendar to include the selected one of the identified second entity events; and
update the second entity electronic calendar to indicate as reserved the selected one of the identified second entity events.
